(19) United States
(12) Patent Application Publication
(10) Pub. No.: US 2024/0342948 A1
(43) Pub. Date: Oct. 17, 2024

(54) BUILDING PANEL AND METHOD TO PRODUCE SUCH BUILDING PANEL

(71) Applicant: Välinge Innovation AB, Viken (SE)

(72) Inventors: Darko PERVAN, VIKEN (SE); Hans PERSSON, PERSTORP (SE); Christer LUNDBLAD, ÖRKELLJUNGA (SE); Mattias SVENSSON, VIKEN (SE); Jan JACOBSSON, VOLLSJÖ (SE); Georg VETTER, HÖGANÄS (SE)

(73) Assignee: Välinge Innovation AB, Viken (SE)

(21) Appl. No.: 18/637,732

(22) Filed: Apr. 17, 2024

(30) Foreign Application Priority Data
Apr. 17, 2023 (SE) 2350455-8

(51) Int. Cl. B27N 3/06; B27N 3/02; B27N 3/20

(52) U.S. Cl. CPC B27N 3/06; B27N 3/02; B27N 3/203

(57) ABSTRACT

A building panel including a multi-layered substrate having a back side layer with lignocellulosic particles and a binder, an intermediate layer with lignocellulosic particles and a binder, arranged on the back side layer, and a front side layer with lignocellulosic particles and a binder, arranged on the intermediate layer. The building panel further includes a front side wood veneer element attached to the front side layer of the multi-layered substrate, and a balancing element attached to the back side layer of the multi-layered substrate. The back side layer was formed from a first mixture, the intermediate layer was formed from a second mixture and the front side layer was formed from a third mixture where lignocellulosic particles from the second mixture and lignocellulosic particles from the third mixture are mixed, at least in a border area between the intermediate layer and the front side layer.

### TECHNICAL FIELD

The present disclosure relates to the field of building panels, e.g., floor panels or wall panels, or furniture components, e.g., drawer panels or countertops. The present disclosure further relates to methods of producing such building panels.

### TECHNICAL BACKGROUND

Within the field of building panels there are a number of different boards for forming the carrier board of the building panel. One example is a fibre board. It is a wood composite that is prepared by mixing wood fibres with thermosetting resin. The fibre board is then hot pressed. Fibre boards can be produced with different densities and a fibre board with a density around 600-800 kg/m³ is referred to as a Medium Density Board (MDF) and a fibre board with a density around 800-1000 kg/m³ is referred to as a High Density Board (HDF). MDF are usually used within the furniture industry as a replacer for solid wood and the HDF is usually used within the flooring industry. A majority of the wood fibres in both the MDF and the HDF are refined long and thin fibres with an aspect ratio, i.e. a ratio between the length of the fibre and its width, of above 40 and sometimes as much as around 100.

Another example of a board is a particle board which may include a similar raw material as fibre boards, i.e. wood based materials. A difference between the two board types is that the density of a particle board is lower, between 500-750, or about 650 kg/m³. Another difference is that the wood material being used for the particle board production is milled into wood chips of different sizes and not refined into fibres as in the fibre board production.

Both of the above mentioned boards are however not optimal for the development that the building panel industry, and perhaps even more the flooring industry, is facing especially when it comes to more or completely water resistant panels, to lighter and thinner products in order to decrease the material consumption, or to decrease the manufacturing costs as the material prices increase.

In order to create a more water resistant building panel the market has tried to incorporate or even switched to thermoplastic material, such as PVC, or used different types of fillers such as Kaolin clay or limestone. Such boards are within the field referred to as LVT, SPC or WPC. Disadvantages with such boards may be that they are rather expensive and temperature sensitive. Further, the ongoing debate whether thermoplastics, such as PVC, are non-environmentally friendly may also be a disadvantage.

All the above boards may then be combined with various surface materials in order to produce a building panel with a decorative surface. Such surface material may be thermosetting resin impregnated paper, thermoplastic foils, wood veneer, or a printed decorative powder layer. In order to balance a building panel having a surface layer the same type of surface layer is preferably placed on the back side of the building panel as well, which is known in the art.

It is known within the field to apply a surface layer onto a board, usually also with a suitable binder in between the board and the surface layer and apply heat and pressure to form the building panel. This can be made in a continuous pressing device or in a discontinuous pressing device, by a single pressing device or multiple pressing devices.

Wood based building panels are moisture sensitive and one problem is that the edges between two building panels swell when exposed to water. Further, the bonding between wood particles may be damaged and the initially compressed wood particles may swell. The swelling becomes permanent since there is nothing to compress the particles again when they have dried when the building panels are installed. The swelling, especially the edge swelling, may e.g. lead to a higher risk of damaging wear on the building panel, especially if the building panel is a floor panel.

### SUMMARY

An object of at least embodiments of the present disclosure is to provide improvements over known art. This object may be achieved by a technique defined in the appended independent claims; certain embodiment being set forth in the related dependent claims.

Another object of at least embodiments of the present disclosure is to decrease the production time and increase the production efficiency of producing a building panel.

Yet another object of at least embodiments of the present disclosure is to increase the water resistance of a building panel comprising lignocellulosic particles.

A further object of at least embodiments of the disclosure is to increase the control and the adaptability of the structure of the building panel in order to be combined with different types of mechanical locking devices.

In a first aspect there is provided a method of producing a building panel, such as a floor panel, a wall panel or a furniture component, comprising:
applying a back side layer comprising a first mixture of at least lignocellulosic particles and a binder,
applying an intermediate layer comprising a second mixture of at least lignocellulosic particles and a binder, on the back side layer,
applying a front side layer comprising a third mixture of at least lignocellulosic particles and a binder, on the intermediate layer,
applying pressure and heat to form said building panel, to cure the binders of the front side layer, the intermediate layer and the back side layer, wherein
at least 50% of the lignocellulosic particles in the second mixture has an aspect ratio of between 1:1 and 30:1.

The aspect ratio is here, and throughout this disclosure, the ratio between the length and the width of the fibres.

Establishing the aspect ratio may for the embodiments in this disclosure be made by, e.g., optical means, by photographing the fibres and digitally measure them. Other suitable means and methods may be used to establish the aspect ratio.

An advantage with the building panel manufactured according to the method as presented above, compared to a standard particle board, is that the density of the building panel is above the density of the particle board which in turn means that the building panel is more adapted to have different kinds of mechanical locking devices arranged in the building panel, where the mechanical locking devices may be one way of increasing the water resistance of a building panel.

Another advantage with the building panel, this time compared to a standard fiber board, is that the building panel, if fluid penetrates the building panel and the building panel partly swells due to the fluid, the swelling will withdraw compared to a fiber board where a swelling will lead to a permanent shape change in the board.

In an embodiment the lignocellulosic particles from the second mixture and lignocellulosic particles from the third mixture are mixed, at least in a border area between the intermediate layer and the front side layer. In an embodiment, the border area between the intermediate layer and the front side layer may be less, or no more, than 10% as thick, such as less, or no more, than 5% as thick as the intermediate layer.

In a further embodiment the lignocellulosic particles from the second mixture and lignocellulosic particles from the first mixture are mixed, at least in a border area between the intermediate layer and the back side layer.

In another embodiment at least 50% of the lignocellulosic particles in the first and/or third mixture has an aspect ratio of between 1:1 and 30:1.

In yet another embodiment the ratio between the amount of the applied second mixture and the total amount of the applied first and third mixture is between 70:30 and 30:70, or between 60:40 and 40:60.

Alternatively, the ratio between the amount of the applied first mixture and the amount of the applied third mixture may be between 40:60 and 60:40, or between 45:55 and 55:45, or about 50:50.

Further, the third mixture and/or the first mixture may comprise an amount of binder between 2% and 10%, between 5% and 35%, or between 10% and 25%. Typically, when a formaldehyde-based binder is used a resin content in the mixture may be between 5% and 35%, or between 10% and 25%. Another example is when an isocyanate-based binder is used, a resin content in the mixture may be between 2% and 10%.

In an embodiment the method further comprises applying a front side element on the front side layer prior to applying pressure and heat to form said building panel, wherein the front side layer is configured to attach to the front side element when pressure and heat is applied to form said building panel.

The front side element may be chosen from a group consisting of a paper sheet, a resin impregnated paper sheet, a cork element, a polymer-based sheet, a prefabricated powder-based sheet, or a powder layer comprising wood fibres and binder. Any of the mentioned front side elements may further be combined with a suitable wear layer, such as a lacquer, an overlay sheet, or any other layer comprising, e.g., wear resistant particles, such as aluminum oxide particles, and/or scratch resistant particles.

Alternatively, the front side element may be a wood veneer element.

In an embodiment the front side layer is configured to penetrate into open features, such as cracks, holes, or pores, of the wood veneer and at least partly fill such open features when pressure and heat is applied.

In another embodiment the third mixture further comprises colorant, such as pigment, dye, or chemical staining agent.

In an embodiment the method further comprises providing a back side element on which the back side layer is applied prior to applying pressure and heat to form said building panel, wherein the back side layer is configured to attach to the back side element when pressure and heat is applied to form said building panel.

The back side element may be chosen from a group consisting of a paper sheet, a resin impregnated paper sheet, a cork element, a polymer-based sheet, a prefabricated powder-based sheet, or a powder layer comprising wood fibres and binder.

Alternatively, the back side element is a wood veneer element.

In an embodiment the method further comprises creating a mechanical locking device along at least one edge portion of the building panel, wherein the mechanical locking device is configured for horizontal and/or vertical locking of similar or essentially identical building panels in an assembled position, the mechanical locking device comprising an upper surface, which is arrange in a front side area of the at least one edge portion, which extends in an essentially parallel direction to a top surface, along at least one edge portion, of the building panel, and which is displaced from said top surface, wherein the upper surface is arranged in the front side layer.

The mechanical locking device may further comprise a locking strip with a locking element, arranged in a back side area of the at least one edge portion and which extends in an essentially parallel direction to a back surface, along at least one edge portion, of the building panel, wherein the locking strip and the locking element are arranged at least partly in the back side layer.

At least 60%, or at least 80% of the locking strip and the locking element may be created in the back side layer.

In an embodiment the building panel is a floor panel, a wall panel, or a furniture component. Examples of a furniture component are a cabinet panel, a drawer panel, or a countertop panel.

In a second aspect of the disclosure there is provided a building panel comprising a multi-layered substrate comprising a back side layer comprising lignocellulosic particles and a binder, an intermediate layer comprising lignocellulosic particles and a binder, arranged on the back side layer, and a front side layer comprising lignocellulosic particles and a binder, arranged on the intermediate layer,
wherein the back side layer was formed from a first mixture, the intermediate layer was formed from a second mixture and the front side layer was formed from a third mixture, wherein at least 50% of the lignocellulosic particles in the second mixture has an aspect ratio of between 1:1 and 30:1.

The aspect ratio is here, and throughout this disclosure, the ratio between the length and the width of the fibres.

An advantage with the building panel presented above, compared to a standard particle board, is that the density of the building panel is above the density of the particle board which in turn means that the building panel is more adapted to have different kinds of mechanical locking devices arranged in the building panel, where the mechanical locking devices may be one way of increasing the water resistance of a building panel.

Another advantage with the building panel, this time compared to a standard fiber board, is that the building panel, even if fluid penetrates the building panel and the building panel partly swells due to the fluid, the swelling will withdraw compared to a fiber board where a swelling will lead to a permanent shape change in the board.

In an embodiment the lignocellulosic particles from the second mixture and lignocellulosic particles from the third mixture are mixed, at least in a border area between the intermediate layer and the front side layer.

In a further embodiment, lignocellulosic particles from the second mixture and lignocellulosic particles from the first mixture are mixed, at least in a border area between the intermediate layer and the back side layer.

In another embodiment at least 50% of the lignocellulosic particles in the first and/or third mixture has an aspect ratio of between 1:1 and 20:1, or between 1:1 and 10:1.

In yet another embodiment the building panel further comprises a front side element attached to the front side layer of the multi-layered substrate.

The front side element may be chosen from a group consisting of a paper sheet, a resin impregnated paper sheet, a cork element, a polymer-based sheet, a prefabricated powder-based sheet, or a powder layer comprising wood fibres and binder. Any of the mentioned front side elements may further be combined with a suitable wear layer, such as a lacquer, an overlay sheet, or any other layer comprising, e.g., wear resistant particles, such as aluminum oxide particles, and/or scratch resistant particles.

Alternatively, the front side element is a wood veneer element.

In an embodiment the building panel further comprises a back side element attached to the back side layer of the multi-layered substrate.

The back side element may be chosen from a group consisting of a paper sheet, a resin impregnated paper sheet, a cork element, a polymer-based sheet, a prefabricated powder-based sheet, or a powder layer comprising wood fibres and binder.

Alternatively, the back side element is a wood veneer element.

In an embodiment the building panel may further comprise a mechanical locking device arranged along at least one edge of the building panel, wherein the mechanical locking device is configured for horizontal and/or vertical locking of similar or essentially identical building panels in an assembled position, the mechanical locking device comprising an upper surface, which is arranged in a front side area of the at least one edge, which extends in an essentially parallel direction to a top surface, along at least one edge, of the building panel, and which is displaced from said top surface, wherein the upper surface is further arranged in the front side layer of the building panel.

The mechanical locking device may further comprise a locking strip with a locking element, which is arranged in a back side area of the at least one edge and which extends in an essentially parallel direction to a back surface, along at least one edge, of the building panel, wherein the locking strip and the locking element are arranged at least partly in the back side layer of the building panel.

The locking strip and the locking element may be arranged in the back side layer, such that at least 60%, or at least 80% of the locking strip and the locking element are arranged in the back side layer.

In an embodiment the building panel is a floor panel, a wall panel, or a furniture component. Examples of a furniture component are a cabinet panel, a drawer panel, or a countertop panel.

In a third aspect of the present disclosure there is provided a method of producing a building panel, such as a floor panel, a wall panel, or a furniture component, comprising:
providing a balancing element,
applying a back side layer comprising a first mixture of at least lignocellulosic particles and a binder, on the balancing element,
applying an intermediate layer comprising a second mixture of at least lignocellulosic particles and a binder, on the back side layer,
applying a front side layer comprising a third mixture of at least lignocellulosic particles and a binder, on the intermediate layer,
applying a front side wood veneer element on the front side layer, and
applying pressure and heat to form said building panel, to cure the binders of the front side layer, the intermediate layer and the back side layer, to attach the front side layer to the front side wood veneer element, and to attach the back side layer to the balancing element,
where the lignocellulosic particles from the second mixture and lignocellulosic particles from the third mixture are mixed, at least in a border area between the intermediate layer and the front side layer, and where the at least 50% of the lignocellulosic particles in the second mixture has an aspect ratio of between 1:1 and 30:1. The aspect ratio is here, and throughout this disclosure, the ratio between the length and the width of the fibres.

An advantage with the building panel manufactured according to the method as presented above, compared to a standard particle board, is that the density of the building panel is above the density of the particle board which in turn means that the building panel is more adapted to have different kinds of mechanical locking devices arranged in the building panel, where the mechanical locking devices may be one way of increasing the water resistance of a building panel.

Another advantage with the building panel, this time compared to a standard fiber board, is that the building panel, even if fluid penetrates the building panel and the building panel partly swells due to the fluid, the swelling will withdraw compared to a fiber board where a swelling will lead to a permanent shape change in the board.

In an embodiment the lignocellulosic particles from the second mixture and lignocellulosic particles from the first mixture are mixed, at least in a border area between the intermediate layer and the back side layer.

In an embodiment at least 50% of the lignocellulosic particles in the first and/or third mixture has an aspect ratio of between 1:1 and 30:1.

In another embodiment the ratio between the amount of the applied second mixture and the total amount of the applied first and third mixture is between 80:20 and 20:80, or between 70:30 and 30:70, or between 60:40 and 40:60.

In yet another embodiment the ratio between the amount of the applied first mixture and the amount of the applied third mixture is between 40:60 and 60:40, or between 45:55 and 55:45, or about 50:50.

Further, the third mixture and/or the first mixture may comprise an amount of binder between 5% and 35%, or between 10% and 25%. As common in wood industry, the amounts are calculated on dry weight, with the amount of bone-dry wood=100% as base. In an embodiment the front side layer is configured to penetrate into open features, such as cracks, holes, or pores, of the front side wood veneer and at least partly fill such open features when pressure and heat is applied.

Further, the third mixture may comprise colorant, such as pigment, dye, or chemical staining agent.

In an embodiment the balancing element is a back side wood veneer element.

The method may further comprise creating a mechanical locking device along at least one edge portion of the building panel, where the mechanical locking device is configured for horizontal and/or vertical locking of similar or essentially identical building panels in an assembled position. The mechanical locking device comprises an upper surface, which is arrange in a front side area of the at least one edge portion and which extends in an essentially parallel direction to a top surface, along at least one edge portion, of the building panel, displaced from said top surface, wherein the upper surface is arranged in the front side layer.

In an embodiment the mechanical locking device further comprises a locking strip with a locking element, arranged in a back side area of the at least one edge portion and which extends in an essentially parallel direction to a back surface, along at least one edge portion, of the building panel, wherein the locking strip and the locking element are arranged at least partly in the back side layer.

Further, at least 60%, or at least 80% of the locking strip and the locking element may be created in the back side layer.

In a fourth aspect of the present disclosure there is provided a building panel, such as a floor panel or wall panel, comprising a multi-layered substrate, which comprises a back side layer comprising lignocellulosic particles and a binder, an intermediate layer comprising lignocellulosic particles and a binder, arranged on the back side layer, and a front side layer comprising lignocellulosic particles and a binder, arranged on the intermediate layer, a front side wood veneer element attached to the front side layer of the multi-layered substrate, and a balancing element attached to the back side layer of the multi-layered substrate, where the back side layer was formed from a first mixture, the intermediate layer was formed from a second mixture and the front side layer was formed from a third mixture. Further, lignocellulosic particles from the second mixture and lignocellulosic particles from the third mixture are mixed, at least in a border area between the intermediate layer and the front side layer. Yet further, at least 50% of the lignocellulosic particles in the second mixture has an aspect ratio of between 1:1 and 30:1. The aspect ratio is here, and throughout this disclosure, the ratio between the length and the width of the fibres.

An advantage with the building panel presented above, compared to a standard particle board, is that the density of the building panel is above the density of the particle board which in turn means that the building panel is more adapted to have different kinds of mechanical locking devices arranged in the building panel, where the mechanical locking devices may be one way of increasing the water resistance of a building panel.

Another advantage with the building panel, this time compared to a standard fiber board, is that the building panel, even if fluid penetrates the building panel and the building panel partly swells due to the fluid, the swelling will withdraw compared to a fiber board where a swelling will lead to a permanent shape change in the board.

In an embodiment the lignocellulosic particles from the second mixture and lignocellulosic particles from the first mixture are mixed, at least in a border area between the intermediate layer and the back side layer.

In another embodiment at least 50% of the lignocellulosic particles in the first and/or third mixture has an aspect ratio of between 1:1 and 20:1, or between 1:1 and 10:1.

The building panel may further comprise a mechanical locking device arranged along at least one edge of the building panel, wherein the mechanical locking device is configured for horizontal and/or vertical locking of similar or essentially identical building panels in an assembled position. The mechanical locking device comprises an upper surface, which is arranged in a front side area of the at least one edge and which extends in an essentially parallel direction to a top surface, along at least one edge, of the building panel, displaced from said top surface, where the upper surface is further arranged in the front side layer of the building panel.

In an embodiment the mechanical locking device further comprises a locking strip with a locking element, which is arranged in a back side area of the at least one edge and which extends in an essentially parallel direction to a back surface, along at least one edge, of the building panel, wherein the locking strip and the locking element are arranged at least partly in the back side layer of the building panel.

Further the locking strip and the locking element are arranged in the back side layer, such that at least 60%, or at least 80% of the locking strip and the locking element are arranged in the back side layer.

### BRIEF DESCRIPTION OF THE DRAWINGS

Embodiments of the disclosure will be described in the following: reference being made to the appended drawings which illustrate non-limiting embodiments of how the disclosure can be reduced into practice.

FIG. 1 is a schematic illustration of a method to produce a building panel according to an embodiment of the present disclosure,

FIG. 2 is a schematic illustration of a method to produce a building panel according to another embodiment of the present disclosure,

FIG. 3 is an illustration of a cross section through layers in a building panel, according to an embodiment of the present disclosure,

FIG. 4 is a schematic illustration of a method to produce a building panel according to yet another embodiment of the present disclosure,

FIG. 5 is a schematic illustration of a method to produce a building panel according to yet another embodiment of the present disclosure,

FIG. 6 is a schematic illustration of a method to produce a building panel according to yet another embodiment of the present disclosure,

FIG. 7A is an illustration of a cross section through layers in a building panel, according to an embodiment of the present disclosure,

FIG. 7B is a photo of the cross section through layers in the building panel as illustrated in FIG. 7A,

FIG. 8 is an illustration of a cross section through a building panel having a front side element with open features, according to an embodiment of the present disclosure,

FIG. 9 is an illustration of a building panel having a front side element with open features, according to an embodiment of the present disclosure,

FIG. 10 is an illustration of a top view of a building panel with a mechanical locking device, according to an embodiment of the present disclosure,

FIG. 11A is an illustration of an assembly of three substantially identical building panels, according to an embodiment of the present disclosure,

FIG. 11B is an illustration of the three building panels in FIG. 11A in an assembled state,

FIG. 12A is an illustration of a cross section of a mechanical locking device according to an embodiment of the present disclosure, in an assembled state arranged along opposite edges of two adjacent building panels,

FIG. 12B is an illustration of a cross section of a mechanical locking device according to another embodiment of the present disclosure, in an assembled state arranged along opposite edges of two adjacent building panels,

FIG. 13 is an illustration of a top view of a displaceable locking tongue according to an embodiment of the present disclosure, for a mechanical locking device,

FIG. 14A is an illustration of a cross section of a building panel according to another embodiment of the present disclosure, in an assembled state arranged along opposite edges of two adjacent panels,

FIG. 14B is an illustration of a cross section of a building panel according to yet another embodiment of the present disclosure, in an assembled state arranged along opposite edges of two adjacent panels,

FIG. 15 is a diagram showing the results of Example 3, and

FIGS. 16-20 show density profiles of different types of building panels and known particle boards and fiber boards.

### DETAILED DESCRIPTION OF EMBODIMENTS

Specific embodiments of the disclosure will now be described with reference to the accompanying drawings. The disclosure may, however, be embodied in many different forms and should not be construed as limited to the embodiments set forth herein; rather, these embodiments are provided so that this disclosure will be thorough and complete, and will fully convey the scope of the disclosure to those skilled in the art. The terminology used in the detailed description of the embodiments illustrated in the accompanying drawings is not intended to be limiting of the disclosure. In the drawings, like numbers refer to like elements.

Generally, in this disclosure, terms like “below” or “lower” typically implies closer to the back surface of the panel or a plane thereof, whereas “above” or “upper” implies closer to the front surface or a plane thereof. The terms “front side” and “back side” imply, respectively, on which side of a center axis, usually a horizontal center axis, the feature is arranged. Further, the thickness direction of the panel is defined as the vertical direction when the panel lays flat on a surface. The horizontal and vertical direction are applicable definition when the building panel is lays flat on e.g. a floor. Instead of horizontal and vertical directions, the description will also refer to a direction parallel with extension of the top or uppermost surface and a direction perpendicular to the extension of the top or uppermost surface. When a building panel is lays flat on e.g. a floor, the horizontal direction is the same as the direction parallel with the extension of the top or uppermost surface and the vertical direction is the same as the direction perpendicular to the extension of the top or uppermost surface.

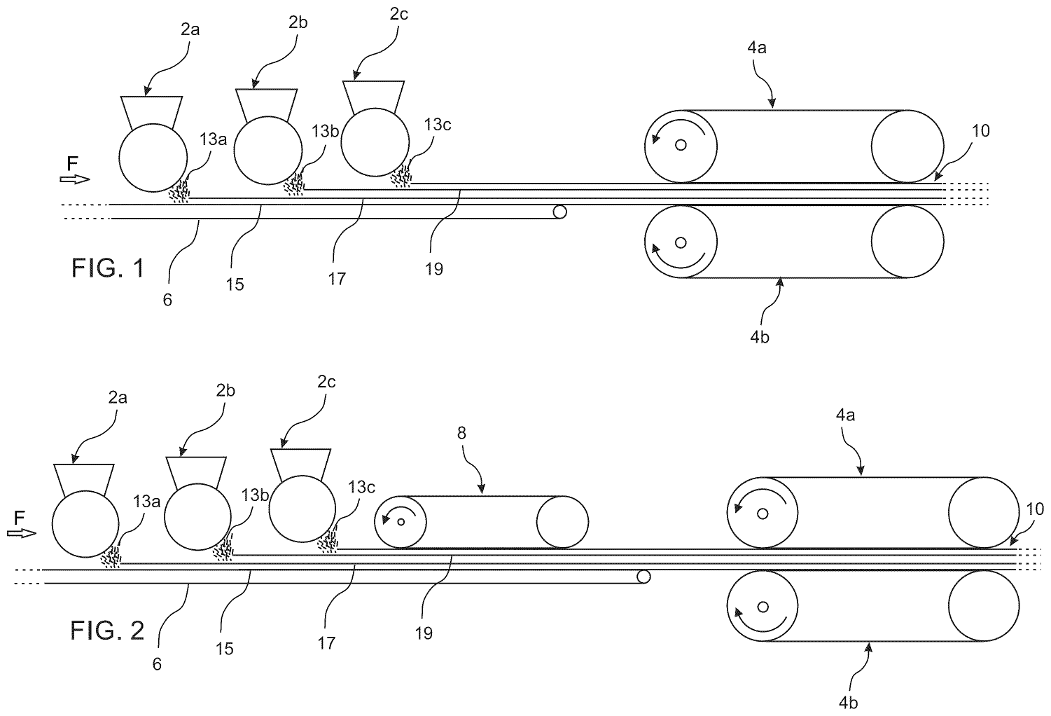

FIGS. 1-2 and 4-6 illustrate different setup possibilities and methods for producing a building panel in accordance with the disclosure. Such a panel may be used as a floor panel, a wall panel, a ceiling panel, or furniture components, e.g., cabinet panels, drawer panels, or countertop panels.

The building panel manufactured by any of the methods illustrated in FIGS. 1 and 2 may either be a building panels which is ready to be used as it is or a building panel which subsequently may be provided with, e.g., a front side element, preferably decorative, such as a paper sheet, a resin impregnated paper sheet, a polymer-based sheet, a prefabricated powder-based sheet, a cork element, or a wood veneer element. Such a surface layer may subsequently be e.g. glued and/or pressed on to the panel. Further, the front side element may be combined with a suitable wear layer, such as a lacquer, an overlay sheet, or any other layer comprising e.g. wear resistant particles, such as aluminum oxide particles, and/or scratch resistant particles, either before pressure and heat is applied or after the building panel has been formed.

Alternatively the building panel may subsequently be painted to achieve a preferred décor of the panel.

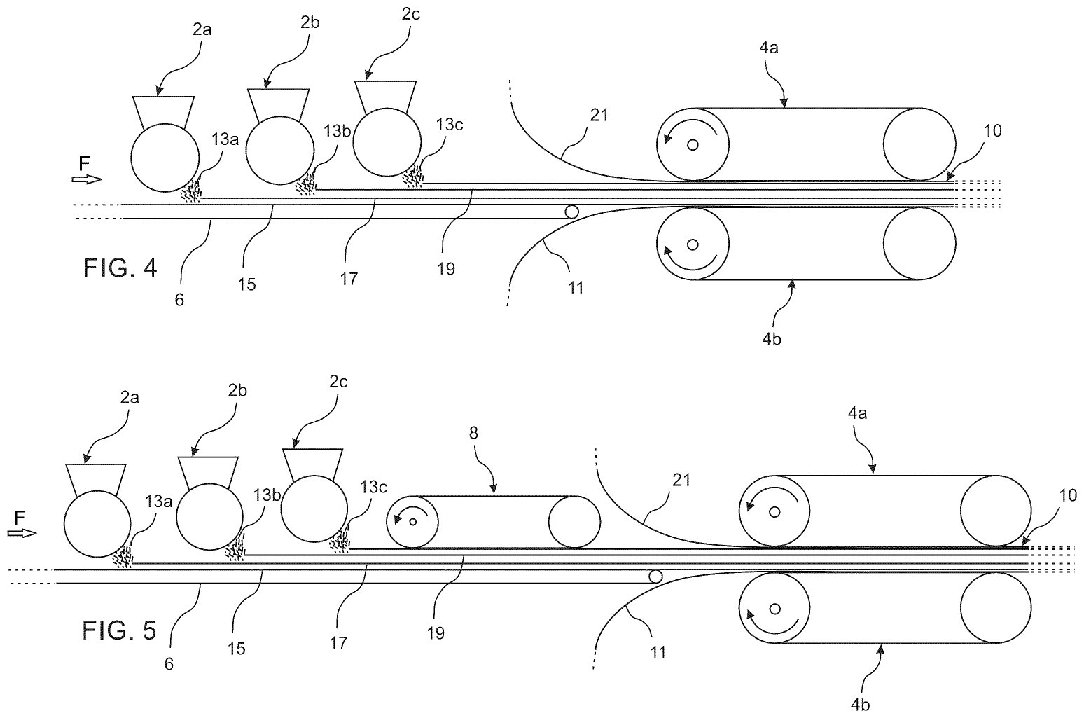

The building panel manufactured by any of the methods illustrated in FIGS. 4-6 is a building panel which is provided with a front side element and/or a back side element already in the manufacturing method. Such a front side element and/or back side element may be a paper sheet, a resin impregnated paper sheet, a polymer-based sheet, a prefabricated powder-based sheet, a powder layer, a cork element, or a wood veneer element.

However, several features in the production setups are the same. For example, each setup has three applicator devices 2a, 2b, 2c which are configured to each apply a mixture 13a, 13b, 13c. The applicator devices 2a, 2b, 2c may scatter the mixtures or roll on the mixtures, i.e. may work either at a distance from where the mixtures are applied or be in contact with where the mixtures are applied. The applicator devices 2a, 2b, 2c may further be configured to handle mixtures of any form, i.e., mixtures in, e.g., dry form or wet form.

Each setup further has at least one building panel forming device 4a, 4b which is configured to apply both heat and pressure to form a building panel. In the illustrated example there is illustrated two opposite building panel forming devices 4a, 4b where one is arranged on the front side and the other is arranged on the back side. Both may be configured to apply both pressure and heat, but it is also possible that there is a difference between the two building panel forming devices 4a, 4b, e.g. one may be configured to apply both heat and pressure while the other is only configured to apply pressure. In the illustrated example the building panel forming devices 4a, 4b are continuous devices working in the feeding direction F. In another embodiment (not illustrated) the building panel forming devices may be discontinuous devices, such as a static device.

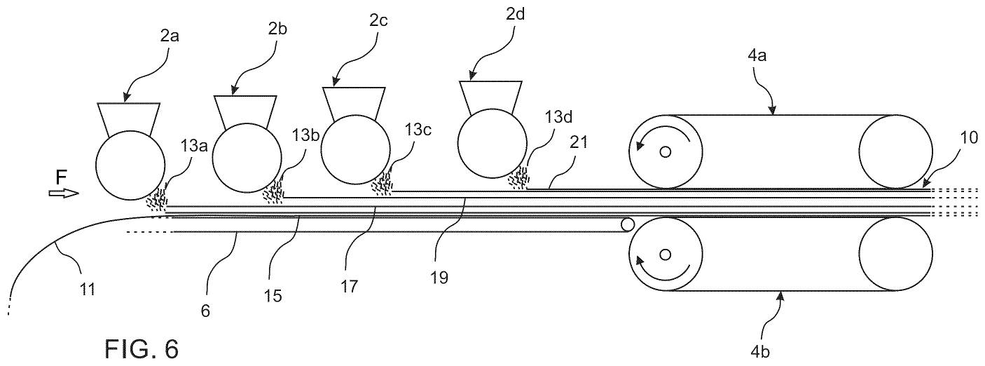

The first applicator device 2a is configured to apply a first mixture 13a to form a back side layer 15 of a building panel 10. In FIGS. 1, 2, 4 and 5 the first mixture 13a is applied onto a carrier 6, such as a conveyor belt or the like, whereas in FIG. 6 the first mixture 13a is applied onto a back side element 11.

The resulting back side layer 15 of the applied and subsequently pressed first mixture 13a preferably has a thickness in the direction perpendicular to the longitudinal extension of a top surface 24 of the building panel 10 which is between 2 mm and 3 mm of a building panel 10 with the total thickness of about 10 mm. The resulting back side layer 15 of the applied and subsequently pressed first mixture 13a preferably has a thickness in the direction perpendicular to the longitudinal extension of a top surface 24 of the building panel 10 which is between 20% and 30% of the total thickness of the building panel 10.

The first mixture 13a includes at least lignocellulosic particles and a binder.

The lignocellulosic particles in the first mixture 13a may be wood particles, e.g. made of pine, oak, eucalyptus, or other wood species, straws from grain products, sisal, coconut, bamboo, hemp, flax, jute, curaua, ramie, or any combination of such particles. The lignocellulosic particles make up between 70% and 99% or above 85% of the first mixture 13a. As common in wood industry, the amounts are calculated on dry weight, with the amount of bone-dry wood=100% as base.

The majority, i.e. at least 50%, of the lignocellulosic particles in the first mixture 13a has a particle size of between 0.3 mm and 0.6 mm. Preferably at least 60%, at least 70%, or at least 80% of the lignocellulosic particles in the first mixture 13a have a particle size of between 0.3 mm and 0.6 mm. In an alternative embodiment, the majority, i.e. at least 50%, of the lignocellulosic particles in the first mixture 13a has a particle size of between 0.3 mm and 1.25 mm. Preferably at least 60%, at least 70%, or at least 80% of the lignocellulosic particles in the first mixture 13a have a particle size of between 0.3 mm and 1.25 mm.

The lignocellulosic particles in the first mixture 13a can also be measured by an aspect ratio, i.e. the ratio between the length of the particle and its width. The aspect ratio of the majority, i.e. at least 50%, of the lignocellulosic particles in the first mixture 13a is below 30. Preferably at least 60%, at least 70%, or at least 80% of the lignocellulosic particles in the first mixture 13a have an aspect ratio below 30. The aspect ratio of the majority, i.e. at least 50%, of the lignocellulosic particles in the first mixture 13a is between 1:1 and 30:1, between 1:1 and 20:1 or between 1:1 and 10:1. Preferably the aspect ratio of at least 60%, at least 70%, or at least 80% of the lignocellulosic particles in the first mixture 13a is between 1:1 and 30:1, between 1:1 and 20:1, or between 1:1 and 10:1. In an embodiment the particle size of the lignocellulosic particles in the first mixture 13a is between 0.3 mm and 1.25 mm, or between 0.3 mm and 0.6 mm and with an aspect ratio less than 20 or less than 10.

The binder in the first mixture 13a may be a thermoset resin. Examples of suitable thermoset resins are amino resins such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof.

The binder make up between 5% and 35%, or between 10 and 25% of the first mixture 13a. As described above, common in wood industry, the amounts are calculated on dry weight, with the amount of bone-dry wood=100% as base. An example is when a formaldehyde-based binder is used a resin content in the mixture may be between 5% and 35%, or between 10% and 25%. Another example is when an isocyanate-based binder is used, a resin content in the mixture may be between 2% and 10%.

The amount of binder in the first mixture 13a, or in any of the mixtures 13b, 13c in this disclosure, may affect the water resistant or water repellant properties of the layers 15, 17, 19 of the building panel 10 which are formed from respective mixture 13a, 13b, 13c. Having more binder in the mixture 13a, 13b, 13c will increase the water resistant or water repellant properties in the building panel 10. However, binder is also the more expensive component of the mixture, thus, an amount as defined above gives a beneficial balance between effect and cost.

The first mixture 13a may further include hydrophobing agent, such as wax. The first mixture 13a may comprise 1-3%, or 1-2% of the hydrophobing agent. Preferred hydrophobing agents are paraffin emulsions. An advantage with having a hydrophobing agent in the first mixture 13a, and in any of the mixtures 13b, 13c in this disclosure, is that it provides the layers 15, 17, 19 of the building panel 10 which are formed from respective mixture 13a, 13b, 13c with improved water repellant properties, in turn creating a more water resistant building panel 10. It may thus be beneficial to add a hydrophobing agent in the mixture 13a, 13b, 13c forming a layer 15, 17, 19 in which features for increasing the water resistant properties of the building panel 10 are created. Examples of this will be described later on.

The first mixture 13a may further comprise different types of additives, such as colorant, catalyst (e.g. ammonium sulphate), formaldehyde scavenger (e.g. urea), or buffer solution.

The second applicator device 2b is configured to apply a second mixture 13b to form an intermediate layer 17 of the building panel 10. In FIGS. 1-2 and 4-6 the second mixture 13b is applied onto the first mixture 13a. As the second mixture 13b is applied onto the first mixture 13a, particles, in particular lignocellulosic particles, from each of the back side layer 15 and the intermediate layer 17 will mix, at least in a border area between the back side layer 15 and the intermediate layer 17.

The resulting intermediate layer 17 of the applied and subsequently pressed second mixture 13b preferably has a thickness in the direction perpendicular to the extension of a top surface 24 of the building panel 10 which is between 1 mm and 20 mm of a building panel 10, resulting in a building panel with the total thickness of between 4 mm and 32 mm. In an embodiment, the resulting intermediate layer 17 of the applied and subsequently pressed second mixture 13b preferably has a thickness in the direction perpendicular to the extension of a top surface 24 of the panel 10 which is between 3 mm and 7 mm of a panel 10, resulting in a panel with the total thickness of about 10 mm. The resulting intermediate layer 17 of the applied and subsequently pressed second mixture 13b preferably has a thickness in the direction perpendicular to the longitudinal extension of the top surface 24 of the building panel 10 which is between 30% and 70% of the total thickness of the building panel 10.

The second mixture 13b includes at least lignocellulosic particles and a binder.

The lignocellulosic particles in the second mixture 13b may be wood particles, e.g. made of pine, oak, eucalyptus, or other wood species, straws from grain products, sisal, coconut, bamboo, hemp, flax, jute, curaua, ramie, or any combination of such particles.

The lignocellulosic particles make up between 70% and 99%, above 75% or above 85% of the second mixture 13b.

The majority, i.e. at least 50%, of the lignocellulosic particles in the second mixture 13b has a particle size of between 0.5 mm and 4 mm, or between 0.5 mm and 2.5 mm, or between 0.5 mm and 1.5 mm, or between 0.6 mm and 1.3 mm. Preferably at least 60%, at least 70% or at least 80% of the lignocellulosic particles in the second mixture 13b have a particle size of between 0.5 mm and 2.5 mm, or between 0.5 mm and 1.5 mm, or between 0.6 mm and 1.3 mm. The lignocellulosic particles in the second mixture 13b can, like explained for the first mixture, also be measured by an aspect ratio, i.e. the ratio between the length of the particle and its width. The aspect ratio of the majority, i.e. at least 50%, of the lignocellulosic particles in the second mixture 13b is below 30. Preferably at least 60%, at least 70%, or at least 80% of the lignocellulosic particles in the second mixture 13b have an aspect ratio below 30. The aspect ratio of the majority, i.e. at least 50%, of the lignocellulosic particles in the second mixture 13b is between 1:1 and 30:1, between 1:1 and 20:1, or between 1:1 and 10:1. Preferably the aspect ratio of at least 60%, at least 70%, or at least 80% of the lignocellulosic particles in the second mixture 13b is between 1:1 and 30:1, between 1:1 and 20:1, or between 1:1 and 10:1. In an embodiment the particle size of the lignocellulosic particles in the second mixture 13b is between 0.6 mm and 1.3 mm and with an aspect ratio less than 10. In another embodiment the particle size of the lignocellulosic particles in the second mixture 13b is between 0.6 mm and 4 mm and with an aspect ratio less than 10.

The binder in the second mixture 13b may be a thermoset resin. Examples of suitable thermoset resins are amino resins such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof. The binder in the second mixture 13b may be the same binder as in the first mixture 13a.

The binder make up between 3% and 20%, or between 5% and 10% of the second mixture 13b. As described above, common in wood industry, the amounts are calculated on dry weight, with the amount of bone-dry wood=100% as base. An example is when a formaldehyde-based binder is used a resin content in the mixture may be between 5% and 35%, or between 10% and 25%. Another example is when an isocyanate-based binder is used, a resin content in the mixture may be between 2% and 10%.

The amount of binder in the second mixture 13b, or in any of the mixtures 13a, 13c in this disclosure, may affect the water resistant or water repellant properties of the layers 15, 17, 19 of the building panel 10 which are formed from respective mixture 13a, 13b, 13c. Having more binder in the mixture 13a, 13b, 13c will increase the water resistant or water repellant properties in the building panel 10. However, binder is also the more expensive component of the mixture, thus, an amount as defined above gives a beneficial balance between effect and cost.

The second mixture 13b may further include hydrophobing agent, such as wax. The second mixture 13b may comprise 1-3%, or 1-2% of the hydrophobing agent. Preferred hydrophobing agents are paraffin emulsions. An advantage with having a hydrophobing agent in the second mixture 13b, and in any of the mixtures 13a, 13c in this disclosure, is that it provides the layers 15, 17, 19 of the building panel 10 which are formed from respective mixture 13a, 13b, 13c with improved water repellant properties, in turn creating a more water resistant building panel 10. It may thus be beneficial to add a hydrophobing agent in the mixture 13a, 13b, 13c forming a layer 15, 17, 19 in which features for increasing the water resistant properties of the building panel 10 are created. Examples of this will be described later on.

The second mixture 13b may further comprise different types of additives, such as colorant, catalyst (e.g. ammonium sulphate), formaldehyde scavenger (e.g. urea), or buffer solution.

The third applicator device 2c is configured to apply a third mixture 13c to form a front side layer 19 of the building panel 10. In FIGS. 1-2 and 4-6 the third mixture 13c is applied onto the second mixture 13b. As the third mixture 13c is applied onto the second mixture 13b, particles, in particular lignocellulosic particles, from each of the intermediate layer 17 and the front side layer 19 will mix, at least in a border area between the front side layer 19 and the intermediate layer 17.

The resulting front side layer 19 of the applied and subsequently pressed third mixture 13c preferably has a thickness in the direction perpendicular to the extension of a top surface 24 of the building panel 10 which is between 2 mm and 3 mm of a building panel 10 with the total thickness of about 10 mm. The resulting front side layer 19 of the applied and subsequently pressed third mixture 13c preferably has a thickness in the direction perpendicular to the longitudinal extension of the top surface 24 of the building panel 10 which is between 20% and 30% of the total thickness of the building panel 10.

The ratio between the amount of the applied third mixture 13c and the amount of the applied first mixture 13a is between 40:60 and 60:40, or between 45:55 and 55:45. The ratio between the amount of the applied third mixture 13c and the amount of the applied first mixture 13a is about 50:50.

The ratio between the amount of the applied second mixture 13b and the total amount of the applied first and third mixture 13a, 13c is between 70:30 and 30:70, or between 60:40 and 40:60. The ratio between the amount of the applied first mixture 13a, the applied second mixture 13b and the applied third mixture 13c may be 20-60-20%, or 25-50-25% or 30-40-30%.

The third mixture 13c includes at least lignocellulosic particles and a binder.

The lignocellulosic particles in the third mixture 13c may be wood particles, e.g. made of pine, oak, eucalyptus, or other wood species, straws from grain products, sisal, coconut, bamboo, hemp, flax, jute, curaua, ramie, or any combination of such particles. The lignocellulosic particles make up between 70% and 99%, or above 85% of the third mixture 13c.

The majority, i.e. at least 50%, of the lignocellulosic particles in the third mixture 13c has a particle size of between 0.3 mm and 0.6 mm. Preferably at least 60%, at least 70%, or at least 80% of the lignocellulosic particles in the third mixture 13c have a particle size of between 0.3 mm and 0.6 mm. In an alternative embodiment, the majority, i.e. at least 50%, of the lignocellulosic particles in the third mixture 13c has a particle size of between 0.3 mm and 1.25 mm. Preferably at least 60%, at least 70%, or at least 80% of the lignocellulosic particles in the third mixture 13c have a particle size of between 0.3 mm and 1.25 mm.

The lignocellulosic particles in the third mixture 13c can, as explained above, also be measured by an aspect ratio, i.e. the ratio between the length of the particle and its width. The aspect ratio of the majority, i.e. at least 50%, of the lignocellulosic particles in the third mixture 13c is below 30. Preferably at least 60%, at least 70% or at least 80% of the lignocellulosic particles in the third mixture 13c have an aspect ratio below 30. The aspect ratio of the majority, i.e. at least 50%, of the lignocellulosic particles in the third mixture 13c is between 1:1 and 30:1, between 1:1 and 20:1, or between 1:1 and 10:1. Preferably the aspect ratio of at least 60%, at least 70%, or at least 80% of the lignocellulosic particles in the third mixture 13c is between 1:1 and 30:1, between 1:1 and 20:1 or between 1:1 and 10:1. In an embodiment the particle size of the lignocellulosic particles in the third mixture 13c is between 0.3 mm and 1.25 mm, or between 0.3 mm and 0.6 mm and with an aspect ratio less than 20 or less than 10.

The binder in the third mixture 13c may be a thermoset resin. Examples of suitable thermoset resins are amino resins such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof. The binder in the third mixture 13c may be the same binder as in the first mixture 13a and/or the second mixture 13b.

The binder make up between 5% and 35%, or between 10% and 25% of the third mixture 13c. As described above, common in wood industry, the amounts are calculated on dry weight, with the amount of bone-dry wood=100% as base. An example is when a formaldehyde-based binder is used a resin content in the mixture may be between 5% and 35%, or between 10% and 25%. Another example is when an isocyanate-based binder is used, a resin content in the mixture may be between 2% and 10%.

The amount of binder in the third mixture 13c, or in any of the mixtures 13a, 13b in this disclosure, may affect the water resistant or water repellant properties of the layers 15, 17, 19 of the building panel 10 which are formed from respective mixture 13a, 13b, 13c. Having more binder in the mixture 13a, 13b, 13c will increase the water resistant or water repellant properties in the building panel 10. However, binder is also the more expensive component of the mixture, thus, an amount as defined above gives a beneficial balance between effect and cost.

The third mixture 13c may further include hydrophobing agent, such as wax. The third mixture 13c may comprise 1-3%, or 1-2% of the hydrophobing agent. Preferred hydrophobing agents are paraffin emulsions. An advantage with having a hydrophobing agent in the third mixture 13c, and in any of the mixtures 13a, 13b in this disclosure, is that it provides the layers 15, 17, 19 of the building panel 10 which are formed from respective mixture 13a, 13b, 13c with improved water repellant properties, in turn creating a more water resistant building panel 10. It may thus be beneficial to add a hydrophobing agent in the mixture 13a, 13b, 13c forming a layer 15, 17, 19 in which features for increasing the water resistant properties of the building panel 10 are created. Examples of this will be described later on.

The third mixture 13c may further include colorant. The colorant may be a pigment, dye, or a chemical staining agent. An example of a chemical staining agent is iron vitriol. By having a colorant in the third mixture 13c it is possible to control and adapt appearance features of the building panel 10. For example if a front side element 21, such as a front side wood veneer element, or top surface has open features 22, such as cracks, holes or the like, the colorant of the third mixture 13c is configured to color the open features 22 as the third mixture 13c penetrates into the open features 22 and at least partly fills such open features 22 when pressure is subsequently is applied.

The third mixture 13c may yet further comprise other types of additives, such as catalyst (e.g. ammonium sulphate), formaldehyde scavenger (e.g. urea) or buffer solution. In order to even further increase the water resistant properties of the building panel 10 the density of each layer 15, 17, 19, formed by the mixtures 13a, 13b, 13c, may be adapted to different water resistant properties designed within the layers 15, 17, 19 of the building panel 10. For example, it may be desirable to, in the front side layer 19, design water resistant features of a mechanical locking device, which will be described in more detail below, and thus, desirable to increase the density of the front side layer 19 in order to even further improve the water resistant features of such a mechanical locking device.

Whereas the intermediate layer 17 may be designed to have no additional water resistant features and therefore does not need an increased density. By adapting the density of each layer, the back side layer 15, the intermediate layer 17 and the front side layer 19 it is possible to both increase the water resistant properties of the building panel 10 where it is desirable to do so and decrease the risk of the building panel 10 becoming too heavy. The weight of the building panel 10 will also depend on the thickness of each of the components of the building panel 10 but by being able to control and adapt the thickness, the density, the lignocellulosic particle sizes, the amount of binder, etc. in each of the back side layer 15, the intermediate layer 17 and the front side layer 19 the weight of the building panel 10 also becomes controllable.

A preferred density of the intermediate layer 17 is less than the density of the front side layer 19 and/or the back side layer 15. A preferred density of the intermediate layer 17 may be between 700-900 kg/m³, or about 800 kg/m³. A preferred density of the front side layer 19 may be between 800-1200 kg/m³, or between 900-1100 kg/m³. In an embodiment the density of the intermediate layer 17 may be between 900-950 kg/m³ where the total thickness of the building panel is about 10 mm.

In order to balance the building panel 10 it is preferred that the back side layer 15, even if it does not have any additional water resistant features designed in it, has the same density as the front side layer 19. Thus, the density of the back side layer 15 is substantially the same as the density of the front side layer 19. Thus, the density of the back side layer 15 may be between 800-1200 kg/m³, or between 900-1100 kg/m³.

There are, however, some differences in the setups between the production methods as illustrated in FIGS. 1, 3 and 4-6. Each method is, however, possible in order to achieve a building panel 10 according to the present disclosure.

In FIGS. 1, 2, 4 and 5 the first mixture 13a is applied onto a carrier 6, in the illustrated example a carrier belt or conveyor belt.

In the embodiment illustrated in FIGS. 4 and 5 a back side element 11, such as a balancing layer, and a front side layer 21, e.g. a wood veneer, are being introduced. The first mixture 13a, the second mixture 13b and the third mixture 13c are transferred onto the back side element 11 such that the first mixture 13a is applied onto to back side element 11. The back side element 11 may be a wood veneer element. However, the back side element 11 may in other embodiments be a paper, an unimpregnated paper or an impregnated paper, a polymer-based sheet, a cork-based element, a prefabricated powder-based sheet, a powder layer comprising wood fibres and binder, or any other suitable back side element.

Further, the front side element 21 is applied onto the third mixture 13c. The front side element 21 may be a wood veneer element. The front side element 19 may in other embodiments be a paper sheet, a resin impregnated paper sheet, a polymer-based sheet, a cork-based element, a prefabricated powder-based sheet, a powder layer comprising wood fibres and binder or, any other suitable front side element. Further, the front side element may be combined with a suitable wear layer, such as a lacquer, an overlay sheet, or any other layer comprising e.g. wear resistant particles, such as aluminum oxide particles, and/or scratch resistant particles, either before pressure and heat is applied or after the building panel has been formed.

After the front side element 21 and the back side element 11 are in place pressure and heat is applied to form the building panel 10.

In the embodiment illustrated in FIGS. 1 and 2 neither a back side element nor a front side element is present, thus, pressure and heat is applied directly to the first mixture 13a and the third mixture 13c for forming the building panel 10.

Pressure and heat is applied preferably by a combined heat and pressure device as the building panel forming device 4a, 4b. In the illustrated examples of FIGS. 1, 2, 4-6 there is one combined heat and pressure device 4a, 4b on each opposite sides of the building panel 10. The heat and pressure devices 4a, 4b are also illustrated as continuous heat and pressure devices feeding the building panel 10 in the feeding direction F.

In alternative setups the heat and pressure devices may be discontinuous devices. It is further possible to only have one single heat and pressure device instead of a double as illustrated. Also, it is possible to have a combined heat and pressure device operating from one side of the building panel and a pressure device, with no added heat, operating from the opposite side of the building panel.

When forming the building panel 10 in a continuous pressing device a pressure of between 20-80 bar, between 40-80 bar, between 50-70 bar, about 50 bar, or about 60 bar is applied, which is applied at a press factor of between 6-16 s/mm, between 7-14 s/mm, or between 8-12 s/mm. Further, a temperature in the press board of between 120-250° C., between 130-200° C., or about 160-180° C. is applied.

In an embodiment the method of forming the building panel 10 may further include creating a pattern in the top surface of the front side layer 19 or, if present, the front side element 21 simultaneously with applying pressure and heat to form the building panel 10. This may be achieved e.g. by a structured press plate (not shown) in the heat and pressing device 4a, or with a displaceable pressing sheet (not shown) which can be arranged in between the front surface of the front side layer 19 or the front side element 21 and the heat and pressure device 4a. By having such a feature in the method it is possible to achieve a desirable and attractive structure or different gloss levels in the top surface.

After the building panel 10 has been formed by the heat and pressure devices 4a, 4b the back side layer 15, the intermediate layer 17 and the front side layer 19, more specifically the binder of each layer, are cured.

Further, if a front side element 21 and/or a back side element 11 is present, the front side layer 19 is attached to the front side element 21 and the back side layer 15 is attached to the back side element 11. Yet further, the front side layer 19 has penetrated into open features 22, if such are present, of the front side element 21, especially if the front side element 21 is a wood veneer element. Open features 22 may be cracks, holes, pores, etc. The front side layer 19 penetrates and at least party fills such open features 22 when heat and pressure is applied. It may be preferred that the front side layer 19 completely fills the open features 22 of the front side element 21.

After the building panel 10 has been heated and pressed the method may further comprise a cooling device (not shown). The cooling device is configured to control the cooling process of the formed building panel and to prevent the building panel to change shape and created unwanted forces within and between the layers of the building panel.

In FIGS. 2 and 5 the methods in FIGS. 1 and 4 are illustrated but with an addition of a pre-pressure method step. Everything that has been described above with reference to FIGS. 1 and 4 also applies for the methods as illustrated in FIGS. 2 and 5.

The addition of the pre-pressure method step is arranged either before the front side element 21 and the back side element 11 is applied or before the main pressure method step is applied to the mixtures 13a, 13b, 13c. The pre-pressure method step is achieved by a pressure device 8, in the illustrated example a continuous pressing device.

The pressure device 8 is configured to press out unwanted air from the first mixture 13a, the second mixture 13b and the third mixture 13c such that unwanted air is not contained and trapped within the back side layer 15, the intermediate layer 17 and the front side layer 19 when the mixtures 13a, 13b, 13c, and more specifically the binders in each mixture 13a, 13b, 13c, are cured. The pressing device 8 is not configured to cure the binders of the mixtures 13a, 13b, 13c, or at least not configured to completely cure the binders of the mixtures 13a, 13b, 13c. The pressing device 8 is arranged after the third mixture 13c has been applied to the second mixture 13b. A further advantage with the pre-pressing method step, besides of removing unwanted air from the mixtures 13a, 13b, 13c, is that the mixtures after the pre-pressing method step may be easier to handle and easier to transfer from the carrier 6 to e.g. the back side element 11 before the building panel 10 is formed.

In FIG. 6 the first mixture 13a is, unlike what is illustrated in previous FIGS., applied directly onto the back side element 11. The back side element 11 is then transported on the carrier 6, i.e. the conveyor belt in the illustrated example, together with the applied first mixture 13a, second mixture 13b and third mixture 13c before the front side element 21 is applied on the third mixture 13c and transferred into the combined heat and pressure devices 4a, 4b for forming the building panel 10.

Just like in FIG. 4, after the front side element 21 is in place, pressure and heat is applied to form the building panel 10. Pressure and heat is applied preferably by the combined heat and pressure devices 4a, 4b.

In alternative setups the heat and pressure devices may be discontinuous devices. It is further possible to only have one single heat and pressure device instead of a double as illustrated. Also, it is possible to have a combined heat and pressure device operating from one side of the building panel and a pressure device, with no added heat, operating from the opposite side of the building panel.

Which has been previously described, when forming the building panel 10 in a continuous pressing device a pressure of between 20-80 bar, between 40-80 bar, between 50-70 bar, or about 50 bar, or about 60 bar is applied, which is applied at a press factor of between 6-16 s/mm, between 7-14 s/mm or between 8-12 s/mm. Further, a temperature in the press board of between 120-250° C., between 130-200° C., or about 160-180° C. is applied.

After the building panel 10 has been formed by the heat and pressure devices 4a, 4b, as the building panel forming device, the back side layer 15, the intermediate layer 17 and the front side layer 19, more specifically the binders of each layer 15, 17, 19, are cured. Further, the front side layer 19 is, if a front side element 21 and/or a back side element 11 is present, attached to the front side element 21 and the back side layer 15 is attached to the back side element 11. Yet further, the front side layer 19 has penetrated into open features 22, if such are present, of the front side element 21, especially if the front side element 21 is a wood veneer element. Open features 22 may be cracks, holes, pores, etc. The front side layer 19 penetrates and at least party fills such open features 22 when heat and pressure is applied. It may be preferred that the front side layer 19 completely fills the open features 22 of the front side element 21.

After the building panel 10 has been heated and pressed the method may further comprise a cooling device (not shown), which has been previously described. The cooling device is configured to control the cooling process of the formed building panel and to prevent the building panel to change shape and created unwanted forces within and between the layers of the building panel.

For the embodiment illustrated in FIG. 6 it may also be possible and preferred to add the pre-pressing method step as described with reference to FIGS. 2 and 5 above, in order to remove unwanted air from the mixtures 13a, 13b, 13c. The pressure device (not shown in this embodiment) may then be arranged after the third mixture 13c has been applied and before the, optional, front side element 21 has been applied on the third mixture 13c.

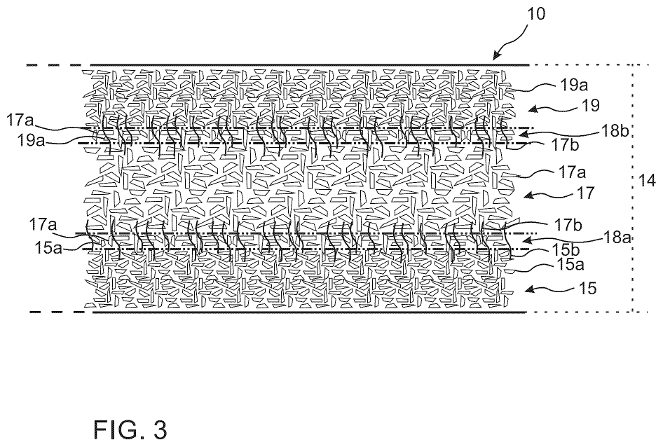

FIG. 3 is a schematic illustration of a cross section of a formed building panel 10, manufactured by any of the methods illustrated FIG. 1 or 2 illustrated in different layers of the building panel 10. The building panel 10 may have a total thickness of between 4 mm and 28 mm.

As explained above, the back side layer 15 has been formed from the first mixture 13a and includes at least lignocellulosic particles 15a and a binder 15b. The intermediate layer 17 was formed from the second mixture 13b and includes at least lignocellulosic particles 17a and a binder 17b. The front side layer 19 was formed from the third mixture 13c and includes at least lignocellulosic particles 19a and a binder 19b.

In between the back side layer 15 and the intermediate layer 17, respective between the intermediate layer 17 and the front side layer 19, there is a border area 18a, 18b between the layers in which lignocellulosic particles 15a, 17a, 19a and occasionally also binder 15b, 17b, 19b from respective layer 15, 17, 19 have been mixed. I.e. in a lower border area 18a, which can also be called a lower transition area, at least lignocellulosic particles 15a, 17a from the back side layer 15 and the intermediate layer 17 are mixed, and in an upper border area 18b, which can also be called an upper transition area, at least lignocellulosic particles 17a, 19a from the intermediate layer 17 and the front side layer 19 are mixed.

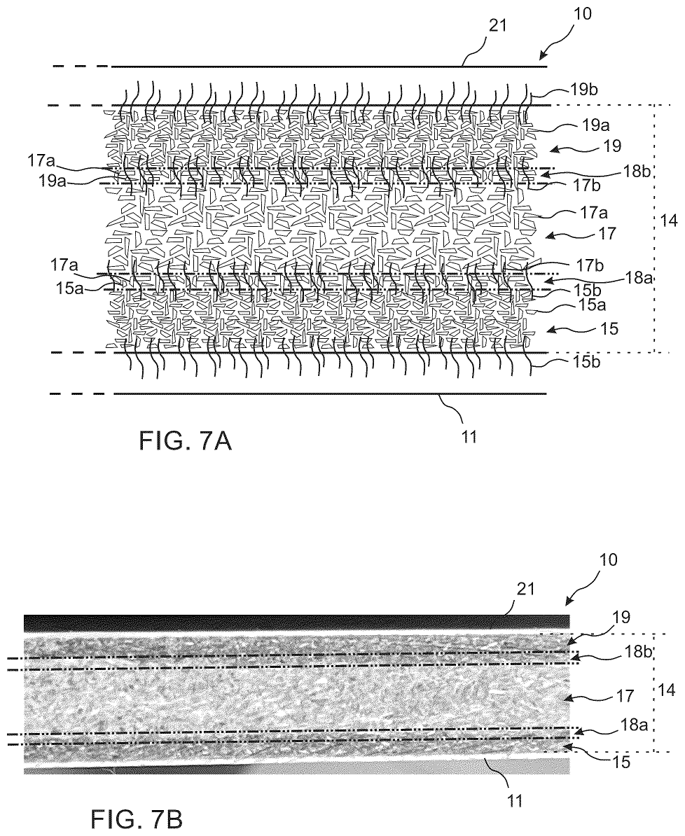

FIG. 7A is a schematic illustration of a cross section of a formed building panel 10, manufactured by any of the methods illustrated in FIGS. 4-6, illustrating the different components of the building panel 10 and FIG. 7B is a photo showing the cross section as described. The building panel 10 may have a total thickness of between 4 mm and 28 mm.

On the bottom, there is the back side element 11, in this case a wood veneer element, and on the top, there is the front side element 21, in this case a wood veneer element. The back side layer 11 may be the same as the front side element 21. However, the back side layer 11 may in other embodiments be, e.g., a paper, an unimpregnated paper or an impregnated paper.

In between the back side element 11 and the front side element 21 there is a multi-layered substrate 14 including the back side layer 15, the intermediate layer 17 and the front side layer 19. The back side layer 15 of the multi-layered substrate 14 is arranged on and attached, by means of the binder 15b in the intermediate layer 15, to the back side element 11. The intermediate layer 17 is arranged in between the back side layer 15 and the front side layer 19. The front side layer 19 of the multi-layered substrate 14 is arranged on and attached, by means of the binder 19b in the front side layer 19, to the front side element 21.

As explained above, the back side layer 15 was formed from the first mixture 13a and includes at least lignocellulosic particles 15a and a binder 15b. The intermediate layer 17 was formed from the second mixture 13b and includes at least lignocellulosic particles 17a and a binder 17b. The front side layer 19 was formed from the third mixture 13c and includes at least lignocellulosic particles 19a and a binder 19b.

The back side layer 15 attaches to the back side element 11 by means of the binder 15b, which has, during the production of the building panel 10, penetrated into the back side element 11, as illustrated in FIG. 7A. The same applies to the opposite side of the building panel 10 where the front side layer 19 attaches to the front side element 21 by means of the binder 19b, which has, during the production of the building panel 10, penetrated into the front side element 21, as illustrated in FIG. 7A.

As previously described, in between the back side layer 15 and the intermediate layer 17, respective between the intermediate layer 17 and the front side layer 19, there is a border area 18a, 18b between the layers in which lignocellulosic particles 15a, 17a, 19a and occasionally also binder 15b, 17b, 19b from respective layer 15, 17, 19 have been mixed. I.e. in a lower border area 18a, which can also be called a lower transition area, at least lignocellulosic particles 15a, 17a from the back side layer 15 and the intermediate layer 17 are mixed, and in an upper border area 18b, which can also be called an upper transition area, at least lignocellulosic particles 17a, 19a from the intermediate layer 17 and the front side layer 19 are mixed.

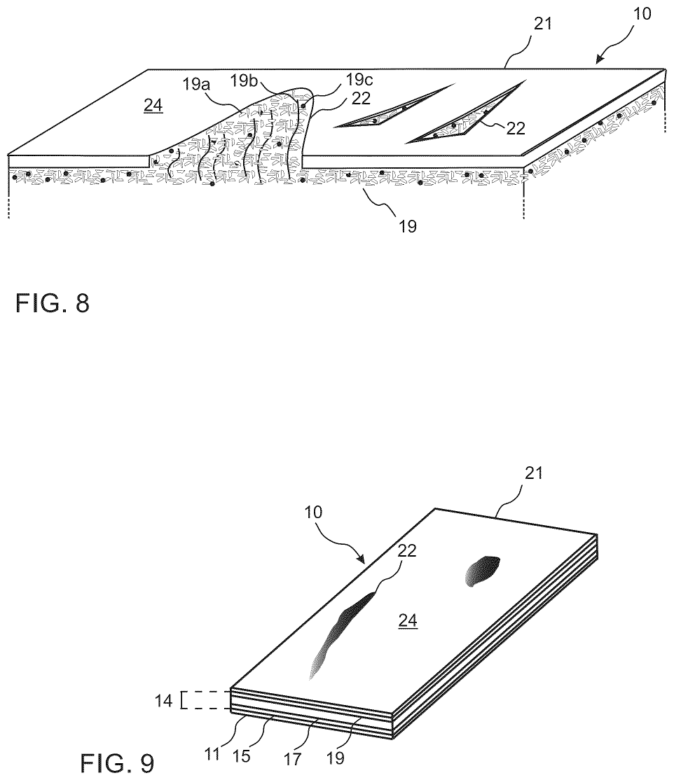

Further, as illustrated in FIGS. 8 and 9, the front side layer 19 is adapted to penetrate open features 22 in the front side element 21 if the front side element 21 has such open features 22, e.g. common where the front side element 21 is a wood veneer element, such that the front side layer 19 at least partly fills the open features 22. Open features may be cracks, holes, pores, or the like. Therefore, it is preferred that the front side layer 19 further includes colorant 19c. The colorant may be a pigment, dye, or a chemical staining agent. An example of a chemical staining agent is iron vitriol. By having a colorant in the front side layer 19 is possible to control and adapt appearance features of the top surface 24 of the building panel 10. For example if the front side element 21 has open features 22, such as cracks, holes, or the like, the colorant of the front side layer 19 is configured to color the open features 22 as the front side layer 19, or the third mixture 13c from which the front side layer 19 is made of, penetrates into the open features 22 and at least partly fills such open features 22 when pressure is subsequently is applied. Preferably, the front side layer 19 substantially completely fills such open features 22, as illustrated in FIGS. 8 and 9.

Thus, the front side layer 19, may be configured to achieve at least three tasks, to mix with the intermediate layer 17, at least in the border area 18b, to attach to the front side element 21 and to at least partly fill open features 22 present in the front side element 21 of the building panel 10.

As described above, the back side layer 15 is made from the first mixture 13a, thus the back side layer 15 includes at least the lignocellulosic particles 15a and the binder 15b.

The lignocellulosic particles 15a may be wood particles, e.g. made of pine, oak, eucalyptus, or other wood species, straws from grain products, sisal, coconut, bamboo, hemp, flax, jute, curaua, ramie, or any combination of such particles. The lignocellulosic particles 15a make up between 70% and 99%, or above 85% of the back side layer 15. As described above, common in wood industry, the amounts are calculated on dry weight, with the amount of bone-dry wood=100% as base.

The majority, i.e. at least 50%, of the lignocellulosic particles 15a in the back side layer 15 has a particle size of between 0.3 mm and 0.6 mm. Preferably at least 60%, at least 70%, or at least 80% of the lignocellulosic particles 15a in the back side layer 15 have a particle size of between 0.3 mm and 0.6 mm. In an alternative embodiment, the majority, i.e. at least 50%, of the lignocellulosic particles in the back side layer 15 has a particle size of between 0.3 mm and 1.25 mm. Preferably at least 60%, at least 70%, or at least 80% of the lignocellulosic particles in the back side layer 15 have a particle size of between 0.3 mm and 1.25 mm.

The lignocellulosic particles 15a in the back side layer 15 can also be measured by an aspect ratio, i.e. the ratio between the length of the particle and its width. The aspect ratio of the majority, i.e. at least 50%, of the lignocellulosic particles 15a is below 30. Preferably at least 60%, at least 70%, or at least 80% of the lignocellulosic particles 15a have an aspect ratio below 30, or below 10. The aspect ratio of the majority, i.e. at least 50%, of the lignocellulosic particles 15a in the back side layer 15 is between 1:1 and 30:1, between 1:1 and 20:1, or between 1:1 and 10:1. Preferably the aspect ratio of at least 60%, at least 70%, or at least 80% of the lignocellulosic particles 15a is between 1:1 and 30:1, between 1:1 and 20:1, or between 1:1 and 10:1. At least 50%, of the lignocellulosic particles 15a in the back side layer 15 has a particle size of between 0.3 mm and 1.25 mm, or between 0.3 mm and 0.6 mm, and an aspect ratio less than 30 or less than 20. In an embodiment the particle size of the lignocellulosic particles 15a in the back side layer 15 is between 0.3 mm and 1.25 mm, or between 0.3 mm and 0.6 mm and with an aspect ratio less than 10.

The binder 15b in the back side layer 15 may be a thermoset resin. Examples of suitable thermoset resins are amino resins such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof. The binder 15b make up between 5% and 30%, or between 10% and 25% of the back side layer 15. As described above, common in wood industry, the amounts are calculated on dry weight, with the amount of bone-dry wood=100% as base.

The amount of binder 15b in the back side layer 15, or in any of the layers 17, 19 in this disclosure, may affect the water resistant or water repellant properties of the layers 15, 17, 19 of the building panel 10. E.g. having more binder in the layers 15, 17, 19 may increase the water resistant or water repellant properties in the building panel 10. However, binder is also the more expensive component of the mixture, thus, an amount as defined above gives a beneficial balance between effect and cost.

Another way of increasing the water resistant or water repellant properties in the building panel is for the back side layer 15 to further include hydrophobing agent, such as wax. The back side layer 15 may comprise 1-3%, or 1-2% of the hydrophobing agent. As described above, common in wood industry, the amounts are calculated on dry weight, with the amount of bone-dry wood=100% as base.

Preferred hydrophobing agents are paraffin emulsions. An advantage with having a hydrophobing agent in the layers 15, 17, 19 of the building panel 10 is that it provides the layers 15, 17, 19 with improved water repellant properties, in turn creating a more water resistant building panel 10. It may thus be beneficial to have a hydrophobing agent in the layer 15, 17, 19 in which features for increasing the water resistant properties of the building panel 10 are created. Examples of this will be described later on.

The back side layer 15 may further comprise different types of additives, such as colorant, catalyst (e.g. ammonium sulphate), formaldehyde scavenger (e.g. urea), or buffer solution. As described above, the intermediate layer 17 is made from the second mixture 13b, thus, the intermediate layer 17 includes at least lignocellulosic particles 17a and the binder 17b.

The lignocellulosic particles 17a in the intermediate layer 17 may be wood particles, e.g. made of pine, oak, eucalyptus, or other wood species, straws from grain products, sisal, coconut, bamboo, hemp, flax, jute, curaua, ramie, or any combination of such particles. The lignocellulosic particles 17a make up between 70% and 99%, or above 85% of the intermediate layer 17. As described above, common in wood industry, the amounts are calculated on dry weight, with the amount of bone-dry wood=100% as base.

The majority, i.e. at least 50%, of the lignocellulosic particles 17a in the intermediate layer 17 has a particle size of between 0.5 mm and 4 mm, or 0.5 mm and 2.5 mm, or between 0.6 mm and 1.3 mm. Preferably at least 60%, at least 70%, or at least 80% of the lignocellulosic particles 17a in the intermediate layer 17 have a particle size of between 0.5 mm and 4 mm, between 0.5 mm and 2.5 mm, or between 0.6 mm and 1.3 mm. The lignocellulosic particles 17a in the intermediate layer 17 can, like explained for the back side layer 15, also be measured by an aspect ratio, i.e. the ratio between the length of the particle and its width. The aspect ratio of the majority, i.e. at least 50%, of the lignocellulosic particles 17a in the intermediate layer 17 is below 30, or below 10. Preferably at least 60%, at least 70%, or at least 80% of the lignocellulosic particles 17a in the intermediate layer 17 have an aspect ratio below 30. The aspect ratio of the majority, i.e. at least 50%, of the lignocellulosic particles 17a in the intermediate layer 17 is between 1:1 and 30:1, between 1:1 and 20:1, or between 1:1 and 10:1. Preferably the aspect ratio of at least 60%, at least 70%, or at least 80% of the lignocellulosic particles 17a in the intermediate layer 17 is between 1:1 and 30:1, between 1:1 and 20:1, or between 1:1 and 10:1. At least 50%, of the lignocellulosic particles 17a in the intermediate layer 17 has a particle size of between 0.6 mm and 2.5 mm, or between 0.6 mm and 1.3 mm, and an aspect ratio less than 30, or less than 10. In an embodiment the particle size of the lignocellulosic particles 17a in the intermediate layer 17 is between 0.6 mm and 2.5 mm, or between 0.6 mm and 1.3 mm and with an aspect ratio less than 10.

The binder 17b in the intermediate layer 17 may be a thermoset resin. Examples of suitable thermoset resins are amino resins such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof. The binder 17b in the intermediate layer 17 may be the same binder as in the back side layer 15.

The binder 17b make up between 3% and 20%, or between 5% and 10% of the intermediate layer 17. As described above, common in wood industry, the amounts are calculated on dry weight, with the amount of bone-dry wood=100% as base.

The amount of binder 17b in the intermediate layer 17, or in any of the layers 15, 19 in this disclosure, may affect the water resistant or water repellant properties of the layers 15, 17, 19 of the building panel. Having more binder in the layers 15, 17, 19 will increase the water resistant or water repellant properties in the building panel 10. However, binder is also the more expensive component of the mixture, thus, an amount as defined above gives a beneficial balance between effect and cost. In an embodiment the binder content in the intermediate layer 17 is lower than the binder content in the front side layer 19 and/or the back side layer 15.

Another way of increasing the water resistant or water repellant properties in the building panel is for the intermediate layer 17 to further include hydrophobing agent, such as wax. The intermediate layer 17 may comprise 1-3%, or 1-2% of the hydrophobing agent. Preferred hydrophobing agents are paraffin emulsions. An advantage with having a hydrophobing agent in the layers 15, 17, 19 of the building panel 10, is that it provides the layers 15, 17, 19 with improved water repellant properties, in turn creating a more water resistant building panel 10. It may thus be beneficial to have a hydrophobing agent in the layer 15, 17, 19 in which features for increasing the water resistant properties of the building panel 10 are created. Examples of this will be described later on.

The intermediate layer 17 may further comprise different types of additives, such as colorant, catalyst (e.g. ammonium sulphate), formaldehyde scavenger (e.g. urea), or buffer solution.

The front side layer 19 includes at least lignocellulosic particles 19a and the binder 19b. The lignocellulosic particles 19a in the front side layer 19 may be wood particles, e.g. made of pine, oak, eucalyptus, or other wood species, straws from grain products, sisal, coconut, bamboo, hemp, flax, jute, curaua, ramie, or any combination of such particles. The lignocellulosic particles 19a make up between 70% and 99%, or above 85% of the front side layer 19. As described above, common in wood industry, the amounts are calculated on dry weight, with the amount of bone-dry wood=100% as base.

The majority, i.e. at least 50%, of the lignocellulosic particles 19a in the front side layer 19 has a particle length of between 0.3 mm and 0.6 mm. Preferably at least 60%, at least 70%, or at least 80% of the lignocellulosic particles in the front side layer 19 have a particle length of between 0.3 mm and 0.6 mm. In an alternative embodiment, the majority, i.e. at least 50%, of the lignocellulosic particles in the front ide layer 19 has a particle size of between 0.3 mm and 1.25 mm. Preferably at least 60%, at least 70%, or at least 80% of the lignocellulosic particles in the front side layer 19 have a particle size of between 0.3 mm and 1.25 mm.

The lignocellulosic particles 19a in the front side layer 19 can, as explained above, also be measured by an aspect ratio, i.e. the ratio between the length of the particle and its width. The aspect ratio of the majority, i.e. at least 50%, of the lignocellulosic particles 19a in the front side layer 19 is below 30. Preferably at least 60%, at least 70%, or at least 80% of the lignocellulosic particles 19a in the front side layer 19 have an aspect ratio below 30. The aspect ratio of the majority, i.e. at least 50%, of the lignocellulosic particles 19a in the front side layer 19 is between 1:1 and 30:1, between 1:1 and 20:1, or between 1:1 and 10:1. Preferably the aspect ratio of at least 60%, at least 70%, or at least 80% of the lignocellulosic particles 19a in the front side layer 19 is between 1:1 and 30:1, between 1:1 and 20:1, or between 1:1 and 10:1. At least 50%, of the lignocellulosic particles 19a in the front side layer 19 has a particle size of between 0.3 mm and 1.25 mm, or between 0.3 mm and 0.6 mm and an aspect ratio less than 30, or less than 10. In an embodiment the particle size of the lignocellulosic particles 19a in the front side layer 19 is between 0.3 mm and 1.25 mm, or between 0.3 mm and 0.6 mm and with an aspect ratio less than 10.

The binder 19b in the front side layer 19 may be a thermoset resin. Examples of suitable thermoset resins are amino resins such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof. The binder 19b in the front side layer 19 may be the same binder as in the first back side layer 15 and/or the intermediate layer 17.

The binder 19b make up between 5% and 30%, or between 10% and 25% of the front side layer 19. The amount of binder 19b in the front side layer 19, or in any of the layers 15, 17 in this disclosure, may affect the water resistant or water repellant properties of the layers 15, 17, 19. Having more binder in the layers 15, 17, 19 will increase the water resistant or water repellant properties in the building panel 10. However, binder is also the more expensive component of the mixture, thus, an amount as defined above gives a beneficial balance between effect and cost.

Another way of increasing the water resistant or water repellant properties in the building panel is for the front side layer 19 to further include hydrophobing agent, such as wax. The front side layer 19 may comprise 1-3%, or 1-2% of the hydrophobing agent. Preferred hydrophobing agents are paraffin emulsions. An advantage with having a hydrophobing agent in layers 15, 17, 19 of the building panel 10 is that it provides the layers 15, 17, 19 with improved water repellant properties, in turn creating a more water resistant building panel 10. It may thus be beneficial to have a hydrophobing agent in the layer 15, 17, 19 in which features for increasing the water resistant properties of the building panel 10 are created. Examples of this will be described later on.

The front side layer 19 may further include colorant 19c, as described above.

The front side layer 19 may further comprise other types of additives, such as catalyst (e.g. ammonium sulphate), formaldehyde scavenger (e.g. urea), or buffer solution.

In order to even further increase the water resistant properties of the building panel 10 the density of each layer 15, 17, 19, may be adapted to different water resistant properties designed within the layers 15, 17, 19 of the building panel 10. For example, it may be desirable to, in the front side layer 19, to design water resistant features of a mechanical locking device, which will be described in more detail below, and thus, desirable to increase the density of the front side layer 19 in order to even further improve the water resistant features of such a mechanical locking device. Whereas the intermediate layer 17 may be designed to have no additional water resistant features and therefore does not need an increased density. By adapting the density of each layer, the back side layer 15, the intermediate layer 17 and the front side layer 19, it is possible to both increase the water resistant properties of the building panel 10 where it is desirable to do so and decrease the risk of the building panel 10 becoming too heavy. The weight of the building panel 10 will also depend on the thickness of each of the components of the building panel 10 but by being able to control and adapt the thickness, the density, the lignocellulosic particle sizes, the amount of binder, etc. in each of the back side layer 15, the intermediate layer 17 and the front side layer 19 the weight of the building panel 10 also becomes controllable.

A preferred density of the intermediate layer 17 is less than the density of the front side layer 19 and/or the back side layer 15. A preferred density of the intermediate layer 17 may be between 700-900 kg/m³, or about 800 kg/m³. A preferred density of the front side layer 19 may be between 800-1200 kg/m³, or between 900-1100 kg/m³. In order to balance the building panel 10 it is preferred that the back side layer 15, even if it does not have any additional water resistant features designed in it, has the same density as the front side layer 19. Thus, the density of the back side layer 15 is substantially the same as the density of the front side layer 19. Thus, the density of the back side layer 15 may be between 800-1200 kg/m³, or between 900-1100 kg/m³.

The building panel 10 preferably has a thickness in the direction perpendicular to the extension of the top surface 24 of between 4 mm and 32 mm, between 6 mm and 15 mm, or about 10 mm.

The ratio between the thickness of the intermediate layer 17 and the and the total thickness of the back side layer 15 and the front side layer 19 is between 70:30 and 30:70, or between 60:40 and 40:60.

The ratio between the thickness of the front side layer 19 and the thickness of the back side layer 15 is between 40:60 and 60:40, or between 45:55 and 55:45. The ratio between the thickness of the front side layer 19 and the thickness of the back side layer 15 is about 50:50.

As explained above the building panel 10 may further include a pattern (not shown) in the top surface of the front side element 21 which has been created simultaneously with applying pressure and heat to form the building panel 10. The pattern may be a desirable and attractive structure or different gloss levels in the top surface 24.

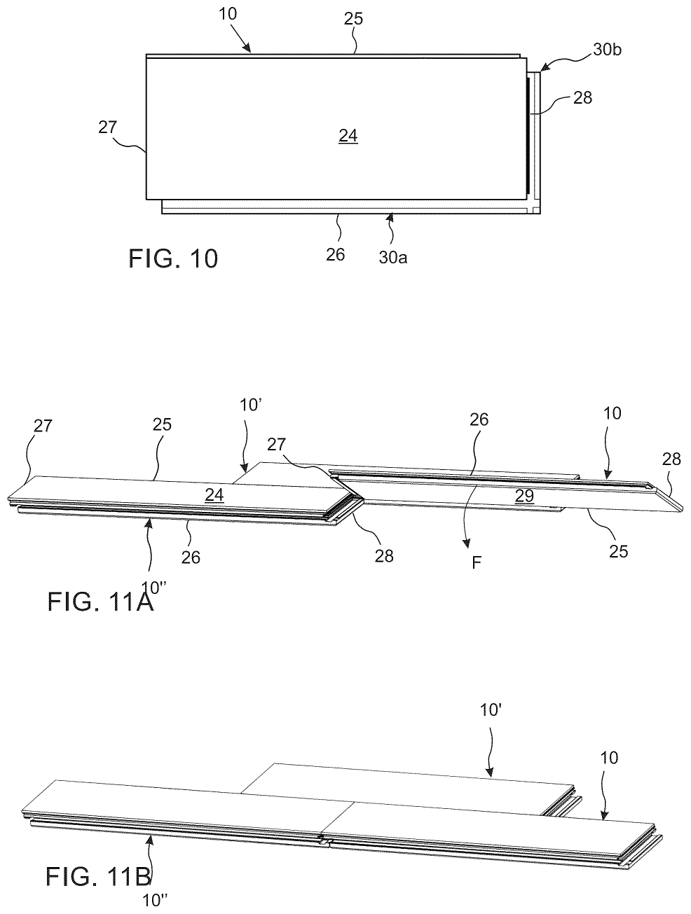

FIG. 10 illustrates a top view of a building panel 10 which may for example be a floor panel, a wall panel, a ceiling panel, a furniture component, or similar. The building panel 10 has a top surface 24, which preferably is the visible surface of the building panel in an assembled state, and a bottom surface 29, which preferably is arranged parallel to and spaced apart from, by the thickness of the building panel 10, the top surface 24. The bottom surface 29 further faces away from the top surface 24. Either the back side layer 13 or, if present the back side element 11 may comprise the bottom surface 29. The top surface 24 may preferably be a decorative top surface. Either the front side layer or, if present, the front side element 21 may comprise the top surface 24.

The building panel further has a first edge portion 25, a second edge portion 26, a third edge portion 27 and a fourth edge portion 28. The second edge portion 26 is arranged opposite the first edge portion 25 and extends in a parallel direction to the first edge portion 25. The fourth edge portion 28 is arranged opposite the third edge portion 27 and extends in a parallel direction to the third edge portion 27. In the illustrated examples the first and second edge portions 25, 26 are the long edge portions of the building panel 10 and the third and fourth edges 27, 28 are the short edge portions of the building panel 10. The building panel 10 is designed to be assembled with similar or substantially identical building panels 10′, 10″ as illustrated in FIGS. 11A and 11B.

In order to assemble similar or essentially identical building panels 10, 10′, 10″ the first edge portion 25 and the second edge portion 26 of the building panel 10 are provided with a first mechanical locking device 30a, configured such that the first edge portion 25 of a building panel 10 is able to mechanically lock to a second edge portion 26 of an adjacent building panel 10′ and vice versa, i.e. the opposite first and second edge portions 25, 26 are designed to be compatible with each other. The first mechanical locking device 30a extends preferably along the entire length of the first and second edge portion 25, 26, respectively. Further, the third edge portion 27 and the fourth edge portion 28 of the building panel 10 are provided with a second mechanical locking device 30b, configured such that the third edge portion 27 of a building panel 20 is able to mechanically lock to a fourth edge portion 28 of an adjacent building panel 20″ and vice versa, i.e. the opposite third and fourth edge portions 27, 27 are designed to be compatible with each other. The second mechanical locking device 30b extends preferably along the entire length of the third and fourth edge portion 25, 26, respectively. Each mechanical locking device 30a, 30b is configured to lock adjacent building panels 10, 10′, 10″ in a horizontal and/or vertical direction, preferably in a horizontal and vertical direction, by means of a folding and/or vertical displacement. To be even more specific, the first mechanical locking device 30a, which is arranged in the first and second edge portion 25, 26 of the building panel is configured to lock adjacent building panels 10, 10′, 10″ in a direction parallel to the longitudinal extension of the third and fourth edge portions 27, 28 and in the direction perpendicular to the longitudinal extension of the third and fourth edge portion 27, 28. The other way around, the second mechanical locking device 30b, which is arranged in the third and fourth edge portion 27, 28 of the building panel is configured to lock adjacent building panels 10, 10′, 10″ in a direction parallel to the longitudinal extension of the first and second edge portion 25, 26 and in the direction perpendicular to the longitudinal extension of the first and second edge portions 25, 26. If such building panels 10, 10′, 10″ are assembled as floor panels, the parallel directions correspond to the horizontal direction and the perpendicular directions correspond to the vertical direction.

A first building panel 10 is assembled to a second building panel 10′ by means of the first mechanical locking device 30a provided along respective first and second edge portions 25, 26 of respective building panel 10, 10′. The first mechanical locking device 30a may be configured to assemble and lock adjacent building panels 10, 10′ in a horizontal and vertical direction by means of a folding displacement F, see FIG. 8A.

When the first building panel 10 is assembled with the second building panel 10′ the first building panel 10 may preferably be displaceable in the horizontal direction such that the first building panel 10 is placed in the right location for being assembled to the third building panel 10″

The first building panel 10 is then assembled to a third building panel 10″ by means of the second mechanical locking device 30b provided along respective third and fourth edge portions 27, 28 of respective building panel 10, 10″. The second mechanical locking device 30b may be configured to assemble and lock adjacent building panels 10, 10″ in a horizontal and vertical direction by means of a vertical displacement, such as vertical folding.

In an alternative installation (not shown) the first building panel may firstly be assembled with the third building panel, along the short side edge, and then assembled to the second building panel, along the long side edge.

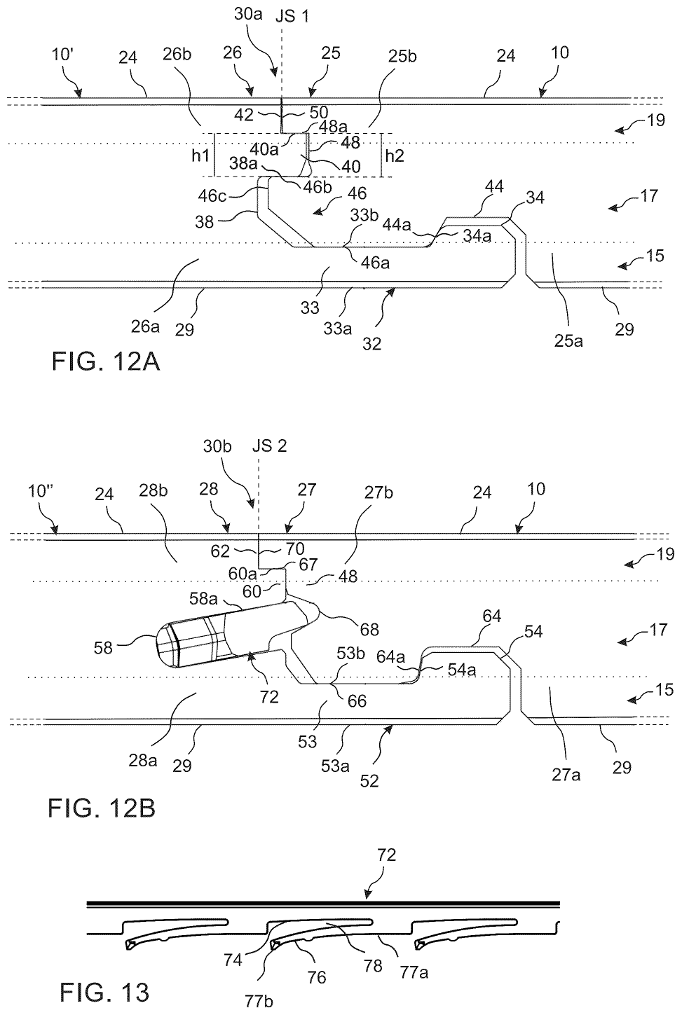

In the assembled position, as is illustrated in FIG. 11B, an upper edge area 25b of the first edge portion 25 of the first building panel 10 and an upper edge area 26b of the second edge portion 26 of the second panel 10′ are juxtaposed to form a joint seal JS1 between the first and second building panel 10, 10′. Further, in the assembled position, an upper edge area 27b of the third edge portion 27 of the first building panel 10 and an upper edge area 28b of the fourth edge portion 28 of the third building panel 10″ are juxtaposed to form a joint seal JS2 between the first and third building panel 10, 10″. These two join seals JS1, JS2 are illustrated in more detail in FIGS. 12A and 12B.

The detailed description of embodiments below is based on the assembling illustrated in FIG. 11B, i.e., with a first, a second and a third building panel 10, 10′, 10″. Since all building panels 10, 10′, 10″ are similar or essentially identical, all features of the mechanical locking device are present on each building panel 10, 10′, 10″.

FIG. 12A illustrate the first mechanical locking device 30a in the assembled state of two adjacent building panels 10, 10′. Preferably, all features of the first mechanical locking device 30a are integrally formed in the first and second edge portion 25, 26, respectively.

The first mechanical locking device 30a comprises along the second edge portion 26 a locking strip 32. The locking strip 32 is arranged at a lower edge area 26a of the edge portion 26, projecting outwards from the lower edge are 26a. The locking strip 32 may be configured to be angularly displaced during the folding displacement.

The locking strip 32 includes, at the outmost end of the locking strip 32, a locking element 34. The locking element 34 is configured to be received in a locking groove 44 arranged in a lower edge area 25a of the first edge portion 25 of an adjacent building panel, by means of the folding displacement.

The locking strip 32 has an elongated shape with the locking element 34 arranged at the outermost end. Between the innermost end of the locking strip 32 and the locking element 34 the locking strip 32 has an elongated body 33. The elongated body 33 has a lower surface 33a facing the bottom surface 29 of the building panel and an upper surface 33b facing in the opposite direction, i.e. towards the top surface 24 of the building panel. The upper surface 33b is preferably plane. The lower surface 33a may be flush with the bottom surface 29 of the building panel.

The upper surface 33b, in the assembled position, extends preferably in the same direction as a lower surface 46a of a locking tongue 46 in the first edge portion 25 of an adjacent building panel, pushing on the upper surface 33b. The upper surface 33b and the lower surface 46a are preferably planar. The upper surface 33b of the elongated body 33 of the locking strip 32 is configured to, in the assembled state, cooperate and preferably at least partly be in contact with the lower surface 46a of the locking tongue 46.

The locking element 34 of the locking strip 32 includes a front locking surface 34a. The front locking surface 34a is arranged at the innermost end of the locking element 34. The upper surface 33b of the elongated body 33 merges into the front locking surface 34a of the locking element 34. The front locking surface 34a of the locking element 34 is configured to, in the assembled state, cooperate and preferably at least partly be in contact with a front wall 44a of a locking groove 44 in the first edge portion 25. The front locking surface 34a of the locking element 34 and the front wall 44a of the locking groove 44 are configured to lock two adjacent building panels in at least a direction parallel to the longitudinal extension of the third and fourth edge portion 27, 28.

The elongated body 33 may be configured to be bendable, to the extent that a portion of the elongated body 33 during installation of two building panels 10, 10′, 10″ may be pushed and displaced downwards.

In order to reduce the risk of affecting the properties of the locking strip 32, e.g. that the elongated body 33 is supposed to flex to a degree during the assembling process it is preferred to control and adapt in which layer 15, 17, 19 of the multi-layered substrate 14 the locking strip 32 is located. It is preferred that most of the locking strip 32 is located in either the back side layer 15 or the intermediate layer 17. In a preferred embodiment, most of the locking strip 32, i.e. at least 60%, or at least 80% of the locking strip 32, is designed in the back side layer 15. Of course the position of the locking strip 32 may be adjusted and adapted to the back side layer 15, e.g. due to a preferred thickness of the back side layer 15. Vice versa, the thickness of the back side layer 15 may be adjusted and adapted to the position of the locking strip 32. This is one of the main advantages with an inventive concept of this disclosure, to be able to adapt and control all features of the building panel without any addition preprocessing of the components of the building panel.

The first mechanical locking device 30a, in the second edge portion 26, further includes a tongue groove 38. The tongue groove 38 is arranged above the locking strip 32 at the innermost end of the locking strip 32 and extends inwards into the second edge portion 26. The tongue groove 38 is configured and shaped to receive a locking tongue 46 in the first edge portion 25 of the adjacent building panel. In the assembled position, the tongue groove 38 and the locking tongue 46 are configured to cooperate and lock two adjacent building panels in at least a direction perpendicular to the longitudinal extension of the third and fourth edge portion 27, 28. The tongue groove 38 and the locking tongue 46 may further be configured to lock two adjacent building panels in the direction parallel to the longitudinal extension of the third and fourth edge portion 27, 28.

An upper wall 38a of the tongue groove 38 may be configured to cooperate and preferably be in contact with an upper surface 46b of the locking tongue 46 in the first edge portion 25 of an adjacent building panel. The upper wall 38a may be configured to lock the locking tongue 38 in the direction perpendicular to the longitudinal extension of the third and fourth edge portion 27, 28.

The first mechanical locking device 30a, in the second edge portion 26, further includes a front side tongue 40. The front side tongue 40 is arranged in an upper edge area 26b of the second edge portion 26 and extends outwards away from the second edge portion 26. The front side tongue 40 is arranged above the tongue groove 38.

The front side tongue 40 is configured and shaped to be received in a front side tongue groove 48 in the first edge portion 25 of the adjacent building panel. In the assembled position, the front side tongue 28 and the front side tongue groove 48 are configured to lock two adjacent building panels in the direction perpendicular, and preferably also parallel, to the longitudinal extension of the third and fourth edge portion 27, 28.

An upper surface 40a, extending in the direction parallel to the longitudinal extension of the third and fourth edge portion 27, 28, of the front side tongue 40 is configured to cooperate and preferably be in contact with an upper wall 48a of the front side tongue groove 48. The upper wall 48a of the front side tongue groove 48 is configured to lock the front side tongue 40 in the direction perpendicular to the longitudinal extension of the third and fourth edge portion 27, 28.

It may be preferred to have a height h1 of the front side tongue 40 of between 0.5 and 2.5 mm. It is preferred for the height h1 of the front side tongue 40 to be greater than the height h2 of the front side tongue groove 48. The difference between the height h1 of the front side tongue 40 and the height h2 of the front side tongue groove 48 is in the range of 0.01 to 0.5 mm, preferably 0.01 to 0.25 mm, more preferably 0.01 to 0.15 mm.

When the front side tongue 40 is arranged in the front side tongue groove 48, in the assembled position, the front side tongue 40 and the front side tongue groove 48 creates a tight seal. This is advantageous since the tight seal obstruct e.g. water, or other fluids, to penetrate further down into the mechanical locking device 30a. It is especially beneficial if the upper surface 40a of the front side tongue 40 creates a tight seal against the upper wall 48a of the front side tongue groove 48 since it is where the fluids are prone to spread out into the rest of the mechanical locking device 30a and the rest of the building panel.

In order to increase the water resistant properties even further it may be desirable to design and position at least the upper surface 40a of the front side tongue 40 in the above described front side layer 19, see the upper dotted lines in FIG. 12A. The features of the front side layer 19, as described above, are controlled such that they contribute to the increased water resistant properties of the mechanical locking device 30a and the building panel 10. This is achieved for example by having a higher density, lignocellulosic particles with a smaller size than for example in the intermediate layer 17, a higher binder content or adding a hydrophobing agent in the front side layer 19. Of course the position of the upper surface 40a of the front side tongue 40 may be adjusted and adapted to the front side layer 19, e.g. due to a preferred thickness of the front side layer 19. Vice versa, the thickness of the front side layer 19 may be adjusted and adapted to the position of the upper surface 40a of the front side tongue 40.

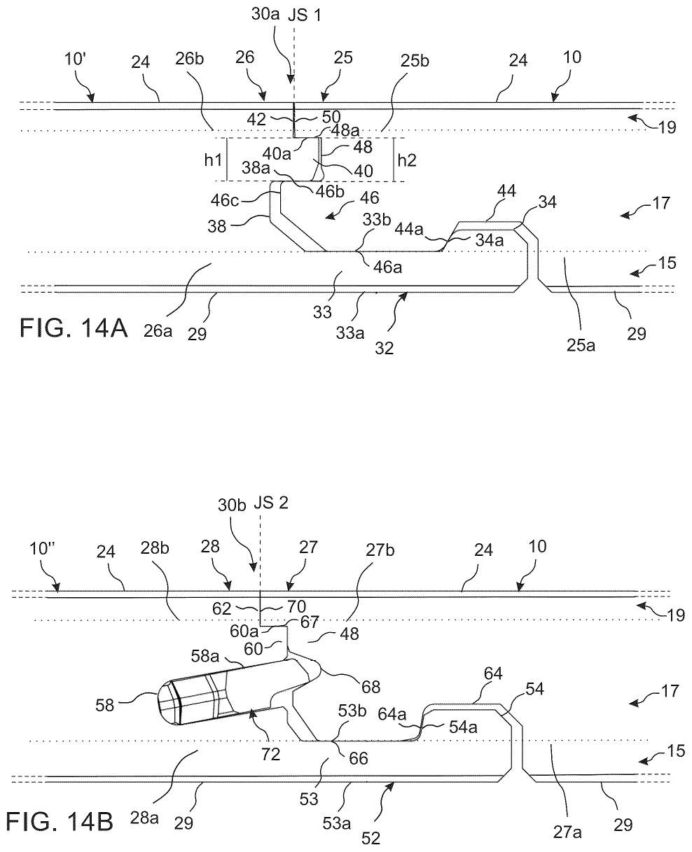

Alternatively, in order to increase the water resistant properties even further it may be desirable to design and position the front side tongue 40 in the intermediate layer 17, see the upper dotted line in FIG. 14A, in order to be able to achieve a controlled swelling of at least the upper surface 40a of the front side tongue 40, when fluid penetrates into the building panel. A controlled swelling of at least the upper surface 40a can provide a tight seal when the front side tongue 40 is arranged in the front side tongue groove 48 and in turn provide increased water resistant properties and prevent fluid from penetrate further into the building panel.

One of the main advantages with an inventive concept of this disclosure, to be able to adapt and control all features of the building panel without any addition preprocessing of the components of the building panel.

At the upper edge area 26b of the second edge portion 26, above the front side tongue 40 there is provided a locking surface 42 extending perpendicular to the upper surface 40a of the front side tongue 40, i.e. extending in the direction perpendicular to the longitudinal extension of the third and fourth edge portion 27, 28. At the upper edge area 25b of the opposite first edge portion 25 there is provided an opposite locking surface 50, extending parallel to the locking surface 42 of the second edge portion 26, i.e. extending in the direction perpendicular to the longitudinal extension of the third and fourth edge portion 27, 28. The locking surface 42 of the second edge portion 26 is configured to cooperate, and preferably be in contact with the locking surface 50 of the first edge portion 25, in the assembled position, as illustrated in FIG. 12A. Together, the locking surface 42 of the second edge portion 26 and the locking surface 50 of the first edge portion 25 form the joint seal JS1. The seal between the two locking surfaces 42, 50 may preferably have a pretension, such that there is a force between the two locking surfaces 42, 50 working towards each other. This pretension may decrease the risk of fluids entering into the mechanical locking device 30a ever further.

Although many of the features of the first mechanical locking device 30a in the first edge portion 25 has been described above, additional features are now described in more detail.

The first mechanical locking device 30a in the first edge portion 25 includes the locking groove 44. The locking groove 44 is arranged in the lower edge area 25a of the first edge portion 25 and extends in a direction upwards into and away from the bottom surface 29 of the building panel.

The locking groove 44 is configured and shaped to receive the locking element 34 of the locking strip 32 of the adjacent building panel. In the assembled position, the locking groove 44 and the locking element 34 are configured to lock two adjacent building panels in at least the direction parallel to the longitudinal extension of the third and fourth edge portion 27, 28. In order to do so the locking groove 44, in the illustrated embodiments, includes a front wall 44a. The front wall 44a is configured to, in the assembled position, cooperate and preferably at least partly be in contact with the front locking surface 34a of the locking element 34 of the adjacent building panel.

Further, the first mechanical locking device 30a in the first edge portion 25 includes a locking tongue 46. The locking tongue 46 extends outwards, in a direction parallel to the longitudinal extension of the third and fourth edge portion 27, 28, away from the first edge portion 25.

The locking tongue 46 is at least partly configured and shaped to be received in the tongue groove 38 in the second edge portion 26 of the adjacent building panel, as explained above.

The locking tongue 46 preferably has an elongated shape where at least an outermost portion 46c is received in the tongue groove 38, in the assembled position. The locking tongue 46 and the outermost portion 46c has an upper surface 46b which is configured to cooperate and preferably be in contact with the upper wall 38a of the tongue groove 38 of the adjacent building panel. The upper wall 38a and the upper surface 46b are configured to lock two adjacent building panels in the direction perpendicular to the longitudinal extension of the third and fourth edge portion 27, 28.

As briefly described above, the locking tongue 46 further has a lower surface 46a. The lower surface 46a may be configured to cooperate and even be in contact with the upper surface 33a of the elongated body 33 of the locking strip 32, in the assembled state. For example, during installation, the lower surface 46a may be configured to displace, and preferably push on, the upper surface 33a of the elongated body 33 of the locking strip 32. As explained above, the locking strip may be flexible allowing the lower surface 46a of the locking tongue 46 to push the locking strip 32 downwards. This movement may increase the preferred pretension in the two parallel locking surfaces 42, 50 in the upper edge area 25b, 26b of respective first and second edge portion 25, 26 of adjacent building panels.

The first mechanical locking device 30a in the first edge portion 25 may also include a front side tongue groove 48. The front side tongue groove 48 is arranged above the locking tongue 46 and extends inwards, into the building panel.

The front side tongue groove 48 is configured and shaped to receive the front side tongue 40 in the second edge portion 26 of the adjacent building panel. In the assembled position, the front side tongue groove 48 and the front side tongue 40 are configured to lock two adjacent building panels in the direction perpendicular to the longitudinal extension of the third and fourth edge portion 27, 28.

As explained above, in order to cause a tight seal, it may be preferred to have a height h1 of the front side tongue 40 of between 0.5 and 2.5 mm. It is preferred for the height h1 of the front side tongue 40 to be greater than the height h2 of the front side tongue groove 48. Thus, as the front side tongue 40 is arranged in the front side tongue groove 48, in the assembled position, the front side tongue 40 and the front side tongue groove 48 creates a tight seal. This is advantageous since the tight seal obstruct e.g., water, or other fluids, to penetrate further down into the mechanical locking device 30a.

Thus, when the front side tongue 40 is arranged in the front side tongue groove 48, in the assembled position, the front side tongue 40 and the front side tongue groove 48 creates a tight seal. This is advantageous since the tight seal obstruct e.g. water, or other fluids, to penetrate further down into the mechanical locking device 30a. It is especially beneficial if the upper surface 40a of the front side tongue 40 creates a tight seal against the upper wall 48a of the front side tongue groove 48 since it is where the fluids are prone to spread out into the rest of the mechanical locking device 30a and the rest of the building panel.

At the upper edge area 25b of the first edge portion 25, above the front side tongue groove 48 there is provided a locking surface 50 extending perpendicular to the upper wall 48a of the front side tongue groove 48, i.e. extending in the direction perpendicular to the longitudinal extension of the third and fourth edge portion 27, 28. At the upper edge area 26b of the opposite second edge portion 26 there is provided the opposite locking surface 42, extending parallel to the locking surface 50 of the first edge portion 25, i.e. extending in the direction perpendicular to the longitudinal extension of the third and fourth edge portion 27, 28. The locking surface 50 of the first edge portion 25 is configured to cooperate, and preferably be in contact with the locking surface 42 of the second edge portion 26, in the assembled position, as illustrated in FIG. 12A. Together, the locking surface 50 of the first edge portion 25 and the locking surface 42 of the second edge portion 26 form the joint seal JS1. The seal between the two locking surfaces 42, 50 may preferably have a pretension, such that there is a force between the two locking surfaces 42, 50 working towards each other. This pretension may decrease the risk of fluids entering into the mechanical locking device 30a ever further. Such a pretension between the two locking surfaces 42, 50 may, in an environment with normal humidity of two building panels each being 100 mm long, be between 2-100N, or between 5-80N.

FIG. 12B illustrate the second mechanical locking device 30b in the assembled state. Preferably, all features, with the exception of a displaceable locking tongue 72, of the second mechanical locking device 30b are integrally formed in the third and fourth edge portion 27, 28, respectively. Much is similar to the first mechanical locking device 30a and its embodiments. The second mechanical locking device 30b is configured to assemble and lock adjacent building panels 10, 10′, 10″ in a direction parallel and perpendicular to the longitudinal extension of the first and second edge portion 25, 26 of the building panel, by means of the vertical displacement.

The second mechanical locking device 30b includes along the fourth edge portion 28 a locking strip 52, preferably integrally formed in the fourth edge portion 28. The locking strip 52 is arranged at a lower edge area 28a of the fourth edge portion 28, projecting outwards from the lower edge area 28a. The locking strip 52 may be configured to be angularly displaced during the vertical displacement.

The locking strip 52 includes, at the outmost end of the locking strip 52, a locking element 54. The locking element 54 is configured to be received in a locking groove 64 arranged in a lower edge area 27a of the third edge portion 27 of an adjacent building panel, by means of the vertical displacement.

The locking strip 52 has an elongated shape with the locking element 54 arranged at the outermost end. Between the innermost end of the locking strip 52 and the locking element 54 the locking strip 52 has an elongated body 53. The elongated body 53 has a lower surface 53a facing the bottom surface 29 of the building panel and an upper surface 53b facing in the opposite direction, i.e. towards the top surface 24 of the building panel.

The upper surface 53b, in the assembled position, extends preferably in the same direction as a lower surface 66 in the lower edge area 27a of the third edge portion 27 of an adjacent building panel, pushing on the upper surface 53b. The upper surface 53b and the lower surface 66 are preferably planar. The upper surface 53b of the elongated body 53 of the locking strip 52 is configured to, in the assembled state, cooperate and preferably at least partly be in contact with the lower surface 66 in the lower edge area 27a of the third edge portion 27.

The locking element 54 of the locking strip 52 includes a front locking surface 54a. The front locking surface 54a is arranged at the innermost end of the locking element 54. The upper surface 53b of the elongated body 53 merges into the front locking surface 54a of the locking element 54. The front locking surface 56 of the locking element 54 is configured to, in the assembled state, cooperate and preferably at least partly be in contact with a front wall 64a of a locking groove 64 in the third edge portion 27. The front locking surface 54a of the locking element 54 and the front wall 64a of the locking groove 64 are configured to lock two adjacent building panels in at least a direction parallel to the longitudinal extension of the first and second edge portion 25, 26.

The elongated body 53 may be configured to be bendable, to the extent that a portion of the elongated body 53 during installation of two building panels 10, 10″ may be pushed and displaced downwards.

In order to reduce the risk of affecting the properties of the locking strip 52, e.g. that the elongated body 53 is supposed to flex to a degree during the assembling process it is preferred to control and adapt in which layer 15, 17, 19 of the multi-layered substrate 14 the locking strip 52 is located. It is preferred that most of the locking strip 52 is located in either the back side layer 15 or the intermediate layer 17. In a preferred embodiment, most of the locking strip 52, i.e. at least 60%, or at least 80% of the locking strip 52, is designed in the back side layer 15. Of course the position of the locking strip 52 may be adjusted and adapted to the back side layer 15, e.g. due to a preferred thickness of the back side layer 15. Vice versa, the thickness of the back side layer 15 may be adjusted and adapted to the position of the locking strip 52. This is one of the main advantages with an inventive concept of this disclosure, to be able to adapt and control all features of the building panel without any addition preprocessing of the components of the building panel.

The second mechanical locking device 30b, in the fourth edge portion 28, further includes a displaceable tongue groove 58. The displaceable tongue groove 58 is arranged above the locking strip 52 at the innermost end of the locking strip 52, and extends inwards, preferably angled, into the fourth edge portion 27.

The displaceable tongue groove 58 is configured and shaped to receive a displaceable locking tongue 72. The displaceable locking tongue 72, when arranged in the displaceable tongue groove 58, is configured to lock two adjacent building panels in at least a direction perpendicular to the longitudinal extension of the first and second edge portion 25, 26, when engaged with a displaceable tongue groove 68 in the third edge portion 27 of the adjacent building panel.

The displaceable locking tongue 72 may be a separate member and comprise the same or a different material than the building panel. The displaceable locking tongue 72 may be made of a polymer-based material. The displaceable locking tongue 72 is described in more detail below with reference to FIG. 13

The first mechanical locking device 30b, in the fourth edge portion 28, further includes a front side tongue 60. The front side tongue 60 is arranged in the upper edge area 28b of the fourth edge portion 28 and extends outwards away from the fourth edge portion 28. The front side tongue 60 is arranged above the displaceable tongue groove 58.

The front side tongue 60 has an upper surface 60a which is configured to cooperate and preferably be in contact with a lower surface 67 arranged in the upper edge area 27b of the third edge portion 27 of the adjacent building panel. The lower surface 67 of the third edge portion 27 is configured to lock the upper surface 60a of the front side tongue 60 in the direction perpendicular to the longitudinal extension of the first and second edge portion 25, 26.

When the upper surface 60a of the front side tongue 60 is locked against the lower surface 67 of the third edge portion 27 of the adjacent building panel, the upper surface 60a and the lower surface 67 creates a tight seal. This is advantageous since the tight seal obstruct e.g. water, or other fluids, to penetrate further down into the mechanical locking device 30a. In order to increase the water resistant properties even further it may be desirable to design and position at least the upper surface 60a of the front side tongue 60 in the above described front side layer 19, see the upper dotted line in FIG. 12B. The features of the front side layer 19, as described above, are controlled such that they contribute to the increased water resistant properties of the mechanical locking device 30b and the building panel 10. This is achieved for example by having a higher density, lignocellulosic particles with a smaller size than for example in the intermediate layer 17, a higher binder content or adding a hydrophobing agent in the front side layer 19. Of course the position of the upper surface 60a of the front side tongue 60 may be adjusted and adapted to the front side layer 19, e.g. due to a preferred thickness of the front side layer 19. Vice versa, the thickness of the front side layer 19 may be adjusted and adapted to the position of the upper surface 60a of the front side tongue 60.

Alternatively, in order to increase the water resistant properties further it may be desirable to design and position the front side tongue 60 in the intermediate layer 17, see the upper dotted lines in FIG. 14B, in order to be able to achieve a controlled swelling of at least the upper surface 60a of the front side tongue 60, when fluid penetrates into the building panel. A controlled swelling of at least the upper surface 60a can provide a tight seal of the front side tongue 60 against the lower surface 67 and in turn provide increased water resistant properties and prevent fluid from penetrate further into the building panel.

One of the main advantages with an inventive concept of this disclosure, to be able to adapt and control all features of the building panel without any addition preprocessing of the components of the building panel.

At the upper edge area 28b of the fourth edge portion 28 above the upper surface 60a of the front side tongue 60 there is provided a locking surface 62 extending perpendicular to the upper surface 60a of the front side tongue 60, i.e. extending in the direction perpendicular to the longitudinal extension of the first and second edge portion 25, 26. At the upper edge area 27b of the opposite third edge portion 27 of the adjacent building panel 1 there is provided an opposite locking surface 70 extending parallel to the locking surface 62 of the fourth edge portion 28, i.e. extending in the direction perpendicular to the longitudinal extension of the first and second edge portion 25, 26. The locking surface 62 of the fourth edge portion 28 is configured to cooperate, and preferably be in contact with the locking surface 70 of the third edge portion 27, in the assembled position, as illustrated in FIG. 12B. Together, the locking surface 62 of the fourth edge portion 28 and the locking surface 70 of the third edge portion 27 form the joint seal JS2. The seal between the two locking surfaces 62, 70 may preferably have a pretension, such that there is a force between the two locking surfaces 62, 70 working towards each other. This pretension may decrease the risk of fluids entering into the mechanical locking device 30b ever further.

Although many of the features of the second mechanical locking device 30b in the third edge portion 27 has been described above, additional features are now described in more detail.

The second mechanical locking device 30b in the third edge portion 27 includes the locking groove 64. The locking groove 64 is arranged in the lower edge area 27a of the third edge portion 27 and extends in a direction upwards into and away from the bottom surface 29 of the building panel.

The locking groove 64 is configured and shaped to receive the locking element 54 of the locking strip 52 of the adjacent building panel. In the assembled position, the locking groove 64 and the locking element 54 are configured to lock two adjacent building panels in at least the direction parallel to the longitudinal extension of the first and second edge portion 25, 26. In order to do so the locking groove 64, in the illustrated embodiments, includes a front wall 64a. The front wall 64a is configured to, in the assembled position, cooperate and preferably at least partly be in contact with the front locking surface 54a of the locking element 54 of the adjacent building panel.

The second mechanical locking device 30b in the third edge portion 27 further preferably has the lower surface 66 as mentioned above. The lower surface 66 is arranged in the lower edge area 27a of the third edge portion 27 of the building panel. The lower surface 66 may be configured to cooperate and even be in contact with the upper surface 53b of the elongated body 53 of the locking strip 52, in the assembled state. For example, during installation, the lower surface 66 may be configured to displace, and preferably push on, the upper surface 53a of the elongated body 53. As explained above, the locking strip may be flexible allowing the lower surface 66 to push the locking strip 52 downwards. This movement may increase the preferred pretension in the two parallel locking surfaces 62, 70 in the upper edge area 27b, 28b of respective third and fourth edge portion 27, 28 of adjacent building panels.

The second mechanical locking device 30b in the third edge portion 27 there is also provided a displaceable tongue groove 68. The displaceable tongue groove 68 is arranged below the lower surface 67 of the upper edge area 27b and above the lower surface 66 of the lower edge area 27a. The displaceable tongue groove 68 is shaped and configured to receive the displaceable locking tongue 72, explained in more detail below. The displaceable tongue groove 68 extends along the longitudinal extension of the third edge portion 27 of the building panel.

The displaceable tongue groove 68 is configured to, together with the displaceable locking tongue 72, lock two adjacent building panels in the direction perpendicular to the longitudinal extension of the first and second edge portion 25, 26.

Above the displaceable tongue groove 68 there is provided the lower surface 67 of the upper edge area 27b of the third edge portion 27. The lower surface 67 extends in a direction parallel to the longitudinal extension of the first and second edge portion 25, 26. The lower surface 67 faces down towards the bottom surface 29 of the building panel. The lower surface 67 is configured to, in the direction perpendicular to the longitudinal extension of the first and second edge portion 25, 26, lock the upper surface 60a of the front side tongue 60 in the assembled position. The lower surface 67 is configured to cooperate and preferably be in contact with the upper surface 60a of the front side tongue 60 in the assembled position.

At the upper edge area 27b of the third edge portion 27, above the lower surface 67 there is provided a locking surface 70 extending perpendicular to the lower surface 67, i.e. extending in the direction perpendicular to the longitudinal extension of the first and second edge portion 25, 26. At the upper edge area 28b of the opposite fourth edge portion 28 there is provided the opposite locking surface 62, extending parallel to the locking surface 70 of the third edge portion 27, i.e. extending in the direction perpendicular to the longitudinal extension of the first and second edge portion 25, 26. The locking surface 70 of the third edge portion 27 is configured to cooperate, and preferably be in contact with the locking surface 62 of the fourth edge portion 28, in the assembled position, as illustrated in FIG. 12B. Together, the locking surface 70 of the third edge portion 27 and the locking surface 62 of the fourth edge portion 28 form the joint seal JS2.

The seal between the two locking surfaces 62, 70 may preferably have a pretension, such that there is a force between the two locking surfaces 62, 70 working towards each other. This pretension may decrease the risk of fluids entering into the mechanical locking device 30b ever further. Such a pretension between the two locking surfaces 62, 70 may, in an environment with normal humidity of two building panels each being 100 mm long, be between 2-100N, or between 5-80N.

Illustrated in FIG. 13 the displaceable locking tongue 72 has a longitudinal base portion 74 which continuously extends along the length of the displaceable locking tongue 72. Along the base portion 74 several elongated flexible or bendable parts 76 are provided. The elongated bendable parts 76 are integrally formed with the base portion 74 at a first end 77a. The opposite second end 77b of the bendable part 76 is configured to move freely between a resting position and an assembled position.

In the resting position, as illustrated in FIG. 13, the elongated bendable parts 76 extend away from the base portion 74, with the second end 77b farthest away from the base portion 74. Between the elongated bendable part 76 and the base portion 74 there is provided a slot, or a gap 78, in the resting position. The bendable part 76 may bend downwards in the slot 78 towards the base portion 74. In an assembled position the bendable parts 76 are bent into the slot 78.

The displaceable locking tongue 72 is configured to be received in the displaceable tongue groove 58 in the fourth edge portion 28 and in the displaceable tongue groove 68 in the third edge portion 27, as illustrated in FIG. 12B.

Before assembling the adjacent building panels 10, 10″ the displaceable locking tongue 72 is arranged in the displaceable tongue groove 58 in the fourth edge portion 28, with the bendable parts 76 facing into the displaceable tongue groove 58 and the longitudinal base portion 74 arranged just outside the displaceable tongue groove 58, facing the building panel to be assembled.

During installation, the building panel 10 is vertically pushed down into the adjacent building panel 10″, where the building panel 10 pushes on the base portion 74, forcing the bendable parts 76 to be displaced into the slot 78 towards the base portion 74, allowing the building panel 10 to continue down. When the building panel 10 is in the assembled position the longitudinal base portion 74 of the displaceable locking tongue 72 snaps into the displaceable tongue groove 68 of the third edge portion 27, locking the two building panels 10, 10″ in the horizontal and vertical direction.

### EXAMPLES

### Example 1: 10 mm Building Panel

In Example 1, a 10 mm three-layered building panel was pressed in a single-opening lab press (500×500 mm) at 180° C. with a pressing time factor of 12 s/mm The building panel was manufactured by applying 20% wt. of the first mixture, or about 1.9 kg/m², forming the back side layer, 60% wt. of the second mixture, or about 5.6 kg/m², forming the intermediate layer, and 20% wt. of the third mixture, forming the front side layer, or about 1.9 kg/m². The second mixture comprised wood particles (mixture of 70% oak and 30% spruce in the size of 0.6-1.25 mm) which were mixed with 10% MUF-resin and 1.5% hydrophobing agent (paraffin emulsion). The first mixture and the third mixture both comprised wood particles (mixture of 70% oak and 30% spruce in the size of 0.315-0.6 mm) which were mixed with 20% MUF-resin and 1.5% hydrophobing agent (paraffin emulsion). Note: as common in wood industry, the amounts are calculated on dry weight, with the amount of bone-dry wood=100% as base.

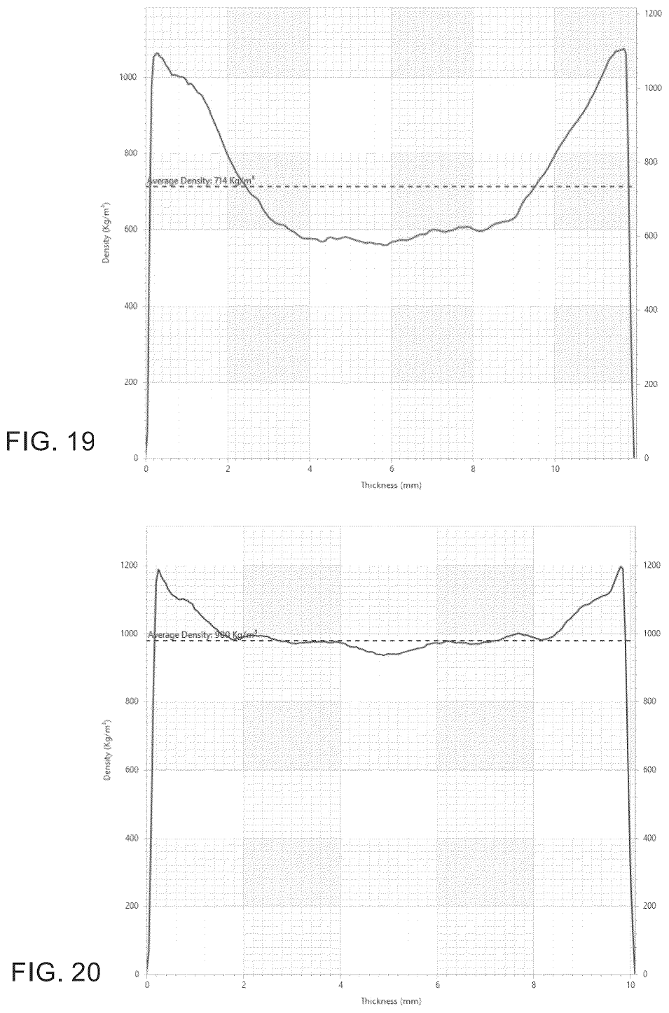

The resulting building panel had a density of 940 kg/m³ (EN 323), compared with a standard particle board of type P5 (according to EN 312) with a density of 655 kg/m³ and a HDF-board in flooring quality with a density of 940 kg/m³. A building panel produced according to Example 1 has a density profile (FIG. 16) closer to a standard HDF-board (FIG. 20) than to a moisture-resistant, load bearing standard particle board of type P5 (FIG. 19).

The resulting building panel had an internal bond of 2.34 N/mm² (EN 319) and showed a thickness swelling of 2.2% (EN 317). Internal bond of the shop-bought type P5 particle board was 0.55 N/mm² and its thickness swelling 7.6%. For the HDF-board, internal bond was 1.95 N/mm² and thickness swelling 10.2%. After thickness swelling test, all samples were dried until bone dry, and thickness measured on the dry samples. The thickness of the building panel from this sample was thinner initially (−1.88%), whereas the HDF board remained thicker than initially (+0.79%), and the type P5 standard particle board in between (−0.62%). This indicates irreversible damage on HDF caused by soaking with water, whereas the building panel and the particle board were not irreversibly damaged. This also can be seen visually with raised edges, whereas no raised edges could be seen on the building panel from this example.

### Example 2: Different Particle Sizes

In Example 2, a 10 mm three-layered building panel were pressed in a single-opening lab press (500×500 mm) at 160° C. with a pressing time factor of 12 s/mm. The building panel was manufactured by applying 20% wt. of the first mixture, or about 1.9 kg/m², forming the back side layer, 60% wt. of the second mixture, or about 5.6 kg/m², forming the intermediate layer, and 20% wt, or about 1.9 kg/m². of the third mixture, forming the front side layer. For the second mixture, wood particles were mixed with 12% MUF-resin and 2.0% hydrophobing agent (paraffin emulsion). For both first mixture and the third mixture, wood particles were mixed with 20% MUF-resin and 1.5% hydrophobing agent (paraffin emulsion). The wood particles used were a mixture of 70% oak, 20% spruce and 10% of a pulpwood graded mixture of species. In a first series, the particle size in the second mixture was 2.5-4.0 mm and in the first and third mixture 0.3-1.25 mm, resulting in a building panel with a density of 916 kg/m³. In a second series, the particle size in the second layer was 0.6-1.25 mm and in the first and third mixture 0.3-0.6 mm, resulting in a building panel with a density of 967 kg/m³.

This trial showed that fine particles are preferred to reach high technological requirements. The building panel with fine particles, i.e. the second series, performed better than the building panel with relatively coarse particles, i.e. the first series. Internal bond (EN 319) for the building panel with fine particles was 3.60 N/mm² and surface soundness (EN 311) 2.80 N/mm². For the building panel with coarse particles, internal bond was 2.74 N/mm² and surface soundness 2.46 N/mm².

### Example 3: Effect of Hydrophobing Agent

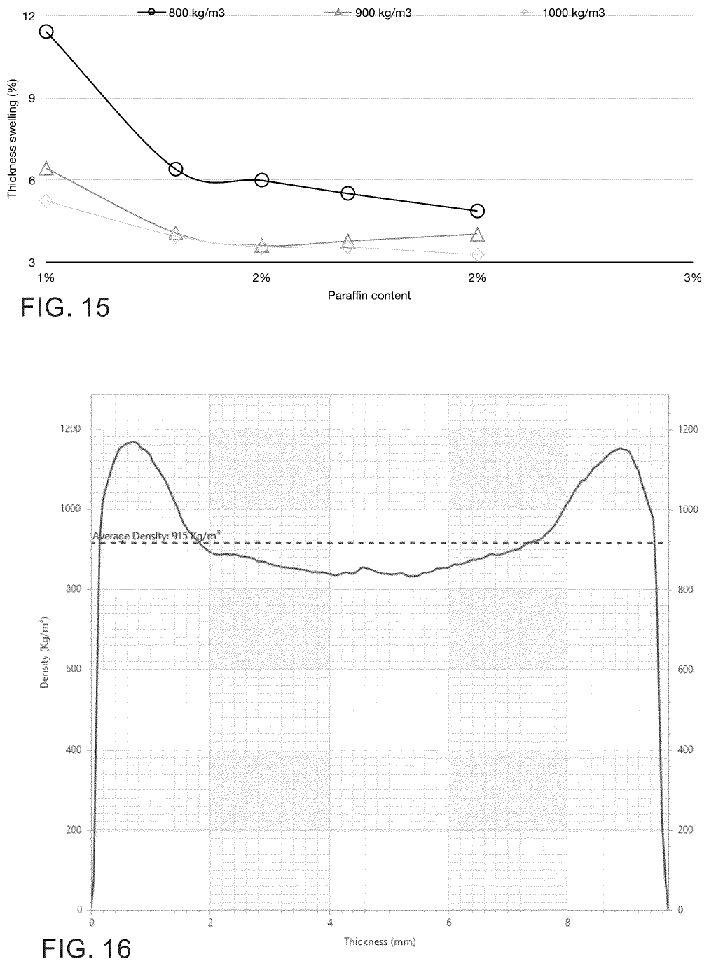

In Example 3, a 10 mm three-layered building panel were pressed in a single-opening lab press (300×300 mm) at 180° C. with a pressing time factor of 12 s/mm in three different density levels (800 kg/m³, 900 kg/m³ and 1000 kg/m³) and five levels of paraffin emulsion (1.0%, 1.3%, 1.5%, 1.7% and 2.0%). The building panel was manufactured by applying 20% wt. of the first mixture, or about 1.60, 1.80, 2.00 kg/m² for each density level, forming the back side layer, 60% wt. of the second mixture, or about 4.80, 5.40, 6.00 kg/m² for each density level, forming the intermediate layer, and 20% wt. of the third mixture, or about 1.60, 1.80, 2.00 kg/m² for each density level, forming the front side layer. For the second mixture, wood particles (mixture of 70% oak and 30% spruce in the size of 0.6-1.25 mm) were mixed with 10% MUF-resin and afore mentioned levels of hydrophobing agent (paraffin emulsion). For both the first and the third mixture, wood particles (mixture of 70% oak and 30% spruce in the size of 0.2-0.6 mm) were mixed with 20% MUF-resin and afore mentioned levels of hydrophobing agent (paraffin emulsion), i.e. 1.0%, 1.3%, 1.5%, 1.7% and 2.0%. The resulting building panels clearly showed a reduction in thickness swelling (EN 317) between 1.0% and 1.3% hydrophobing agent, see FIG. 15. Increased hydrophobing agent content above 1.3% showed no or just marginal improvement in thickness swelling.

### Example 4: High Performance Building Panel

In Example 4, a 10 mm three-layered building panel was pressed in a single-opening lab press (500×500 mm) at 160° C. with a pressing time factor of 12 s/mm. The building panel was manufactured by applying 20% wt. of the first mixture, or about 2.0 kg/m², forming the back side layer, 60% wt. of the second mixture, or about 5.5 kg/m², forming the intermediate layer, and 20% wt. of the third mixture, or about 2.0 kg/m², forming the front side layer. For the second mixture, wood particles (mixture of 70% oak and 30% spruce in the size of 0.6-1.25 mm) were mixed with 12% MUF-resin and 3.0% hydrophobing agent (paraffin emulsion). For both first and third mixture, wood particles (mixture of 70% oak and 30% spruce in the size of 0.315-0.6 mm) were mixed with 20% MUF-resin and 2.5% hydrophobing agent (paraffin emulsion). The resulting building panel had a density of 990 kg/m³ (EN 323). The resulting building panel had an internal bond of 3.61 N/mm² (EN 319) and showed a thickness swelling of 2.1% (EN 317). Modulus of elasticity (EN 310) of this building panel was 5212 MPa and bending strength (EN 310) 34.4 N/mm², which is far above what EN 312 requires for heavy-duty load-bearing particle boards of type P7.

### Example 5: 16 mm Building Panel, Preferably Used as a Furniture Panel

In Example 5, a 16 mm three-layered building panel was pressed in a single-opening lab press (500×500 mm) at 160° C. with a pressing time factor of 15 s/mm. The building panel was manufactured by applying 20% wt. of the first mixture, or about 2.0 kg/m², forming the back side layer, 60% wt of the second mixture, or about 6.1 kg/m², forming the intermediate layer, and 20% wt of the third mixture, or about 2.0 kg/m², forming the front side layer. For the second mixture, wood particles (mixture of 70% oak, 20% spruce and 10% unknown mixture in the size of 1.54-4.0 mm) were mixed with 8% MUF-resin and 1.5% hydrophobing agent (paraffin emulsion). For both the first and the third mixture, wood particles (mixture of 70% oak, 20% spruce and 10% unknown mixture in the size of 0.3-1.25 mm) were mixed with 12% MUF-resin and 1.5% hydrophobing agent (paraffin emulsion). The resulting building panel had a density of 635 kg/m³ (EN 323). The resulting building panel had an internal bond of 0.46 N/mm² (EN 319) and showed a thickness swelling of 8.9% (EN 317).

### Example 6: 30 mm Building Panel, Preferably Used as a Countertop

In Example 6, a 30 mm three-layered building panel was pressed in a single-opening lab press (500×500 mm) at 160° C. with a pressing time factor of 15 s/mm. The building panel was manufactured by applying 20% wt. of the first mixture, or about 3.8 kg/m², forming the back side layer, 60% wt. of the second mixture, or about 11.3 kg/m², forming the intermediate layer, and 20% wt. of the third mixture, or about 3.8 kg/m², forming the front side layer. For the second mixture, wood particles (mixture of 70% oak, 20% spruce and 10% unknown mixture in the size of 1.54-4.0 mm) were mixed with 8% MUF-resin and 1.5% hydrophobing agent (paraffin emulsion). For both the first and the third mixture, wood particles (mixture of 70% oak, 20% spruce and 10% unknown mixture in the size of 0.3-1.25 mm) were mixed with 12% MUF-resin and 1.5% hydrophobing agent (paraffin emulsion). The resulting building panel had a density of 625 kg/m³ (EN 323). The resulting building panel had an internal bond of 0.38 N/mm² (EN 319) and showed a thickness swelling of 9.2% (EN 317).

### Example 7: 11 mm Building Panel with a Wood Veneer as Front Side Element, Preferably Used as a Floor Panel

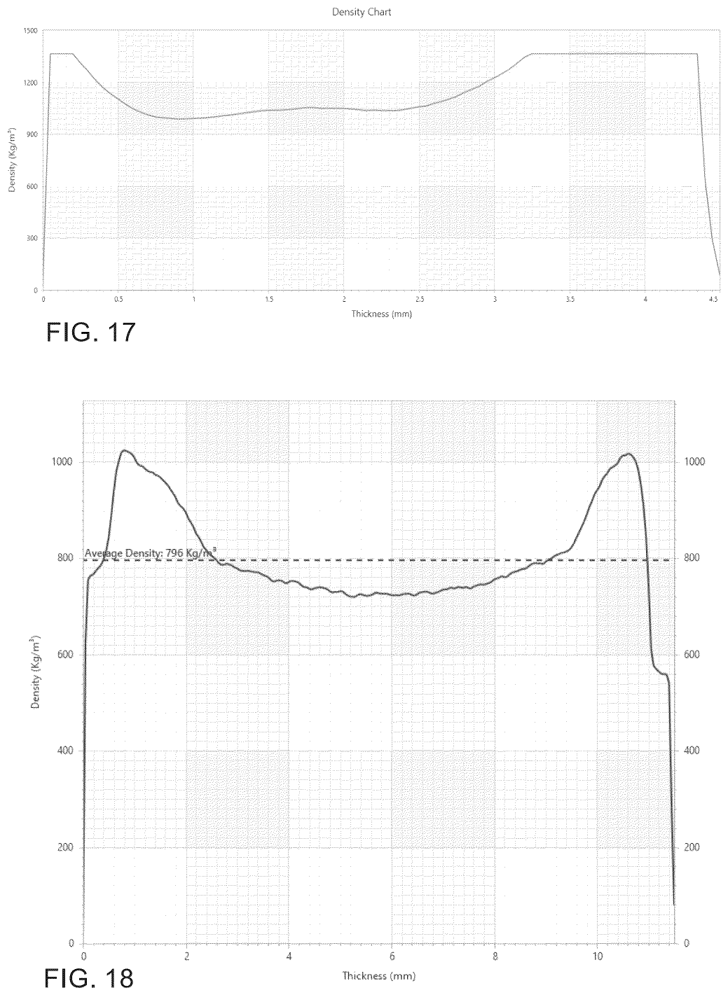

In Example 7, a 11 mm building panel was pressed in a single-opening lab press (500×500 mm) at 170° C. with a pressing time factor of 12 s/mm. The five-layered building panel was manufactured by providing a balancing layer of birch veneer, applying 20% wt. of the first mixture, or about 1.7 kg/m², forming the back side layer, 60% wt. of the second mixture, or about 4.9 kg/m², forming the intermediate layer, 20% wt. of the third mixture, or about 1.7 kg/m², forming the front side layer, and a decorative layer of oak veneer. For the second mixture, wood particles (mixture of 70% oak, 20% spruce and 10% unknown mixture in the size of 0.6-1.25 mm) were mixed with 12% MUF-resin and 2.0% hydrophobing agent (paraffin emulsion). For both the first and the third mixture, wood particles (mixture of 70% oak, 20% spruce and 10% unknown mixture in the size of 0.3-0.6 mm) were mixed with 25% MUF-resin and 1.0% hydrophobing agent (paraffin emulsion). The resulting building panel had a density of 824 kg/m³ (EN 323), and a typical density profile is shown in FIG. 18. The resulting building panel had a surface soundness (EN 311) of 2.25 N/mm².

### Example 8: 6 mm Building Panel

In Example 8, a 6 mm three-layered building panel was pressed in a single-opening lab press (500×500 mm) at 130° C. with a pressing time factor of 20 s/mm. The building panel was manufactured by applying about 4 kg/m² of the first mixture, forming the back side layer, about 4 kg/m² of the second mixture, forming the intermediate layer, and about 4 kg/m² of the third mixture, forming the front side layer. The second mixture comprised wood particles (mixture of 70% oak and 20% spruce and 10% unknown mixture in the size of 0.315-0.6 mm) which were mixed with 20% MUF-resin and 2.0% hydrophobing agent (paraffin emulsion). The first mixture and the third mixture both comprised wood particles (unknown mixture in the size of 0.05-0.3 mm) which were mixed with 145% MF-resin, 15% pigments and 30% corundum particles. The resulting building panel had a density of 1150 kg/m³ (EN323). A typical density profile of the 6 mm building panel is shown in FIG. 17. The actual maximum density is higher than depicted, but since the actual density is out of the measuring range of the machine, the tops are cut at about 1350 kg/m³.

Finally, although the disclosure has been described above with reference to specific embodiments, it is not intended to be limited to the specific form set forth herein. Rather, the disclosure is limited only by the accompanying claims. Other embodiments than the specific above are equally possible within the scope of the appended claims. All embodiments may be used separately or in combinations. Angles, dimensions, rounded parts, spaces between surfaces, etc. are only examples and may be adjusted within the basic principles of the disclosure.

### Items

Item 1. A method of producing a building panel, such as a floor panel, or wall panel, comprising:
providing a balancing element (11),
applying a back side layer (15) comprising a first mixture of at least lignocellulosic particles and a binder, on the balancing element (11),
applying an intermediate layer (17) comprising a second mixture of at least lignocellulosic particles and a binder, on the back side layer (15),
applying a front side layer (19) comprising a third mixture of at least lignocellulosic particles and a binder, on the intermediate layer (17),
applying a front side wood veneer element (21) on the front side layer (19), and
applying pressure and heat to form said building panel (10), to cure the front side layer (19), the intermediate layer (17) and the back side layer (15) to attach the front side layer (19) to the front side wood veneer element (21), and to attach the back side layer (15) to the balancing element (11),
wherein lignocellulosic particles from the second mixture and lignocellulosic particles from the third mixture are mixed, at least in a border area (18b) between the intermediate layer (17) and the front side layer (19), and
wherein the at least 50% of the lignocellulosic particles in the second mixture has an aspect ratio of between 1:1 and 30:1.

Item 2. The method according to item 1, wherein lignocellulosic particles from the second mixture and lignocellulosic particles from the first mixture are mixed, at least in a border area (18a) between the intermediate layer (17) and the back side layer (15).

Item 3. The method according to item 1 or 2, wherein at least 50% of the lignocellulosic particles in the first and/or third mixture has an aspect ratio of between 1:1 and 30:1.

Item 4. The method according to any one of the preceding items, wherein the ratio between the amount of the applied second mixture and the total amount of the applied first and third mixture is between 70:30 and 30:70, or between 60:40 and 40:60

Item 5. The method according to any one of the preceding items, wherein the ratio between the amount of the applied first mixture and the amount of the applied third mixture is between 40:60 and 60:40, or between 45:55 and 55:45, or about 50:50.

Item 6. The method according to any one of the preceding items, wherein the third mixture and/or the first mixture comprises an amount of binder between 5% and 35%, or between 10% and 25%.

Item 7. The method according to any one of the preceding items, wherein the front side layer (19) is configured to penetrate into open features (22), such as cracks, holes, or pores, of the front side wood veneer (21) and at least partly fill such open features (22) when pressure and heat is applied.

Item 8. The method according to any one of the preceding items, wherein the third mixture further comprises colorant, such as pigment, dye, or chemical staining agent.

Item 9. The method according the any one of the preceding items, wherein the balancing element (11) is a back side wood veneer element.

Item 10. The method according to any one of the preceding items, further comprising:
creating a mechanical locking device (30a; 30b) along at least one edge portion (25, 26, 27, 28) of the building panel (10), wherein the mechanical locking device (30a; 30b) is configured for horizontal and/or vertical locking of similar or essentially identical building panels (10) in an assembled position, the mechanical locking device (30a; 30b) comprising
an upper surface (40a; 60a), which is arrange in a front side area (26b; 28b) of the at least one edge portion (25, 26, 27, 28) and which extends in an essentially parallel direction to a top surface (24), along at least one edge portion (25, 26, 27, 28), of the building panel (10), displaced from said top surface (24), wherein the upper surface (40a; 60a) is arranged in the front side layer (19).

Item 11. The method according to item 10, wherein the mechanical locking device (30a; 30b) further comprises:
a locking strip (32; 52) with a locking element (34; 54), arranged in a back side area (26a; 28a) of the at least one edge portion (25, 26, 27, 28) and which extends in an essentially parallel direction to a back surface (29), along at least one edge portion (25, 26, 27, 28), of the building panel (10), wherein the locking strip (32; 52) and the locking element (34:54) are arranged at least partly in the back side layer (15).

Item 12. The method according to item 11, wherein at least 60%, or at least 80% of the locking strip (32; 52) and the locking element (34; 54) are created in the back side layer (15).

Item 13. A building panel, such as a floor panel, or wall panel manufactured by the method according to any one of the claims 1-12.

Item 14. A building panel, such as a floor panel, or wall panel, comprising
a multi-layered substrate (14) comprising
   a back side layer (15) comprising lignocellulosic particles and a binder,
   an intermediate layer (17) comprising lignocellulosic particles and a binder, arranged on the back side layer (15), and
   a front side layer (19) comprising lignocellulosic particles and a binder, arranged on the intermediate layer (17),
a front side wood veneer element (21) attached to the front side layer (19) of the multi-layered substrate (14), and
a balancing element (11) attached to the back side layer (15) of the multi-layered substrate (14), wherein
the back side layer (15) was formed from a first mixture, the intermediate layer (17) was formed from a second mixture and the front side layer (19) was formed from a third mixture, wherein
lignocellulosic particles from the second mixture and lignocellulosic particles from the third mixture are mixed, at least in a border area (18b) between the intermediate layer (17) and the front side layer (19), and wherein
at least 50% of the lignocellulosic particles in the second mixture has an aspect ratio of between 1:1 and 30:1.

Item 15. The building panel according to item 14, wherein lignocellulosic particles from the second mixture and lignocellulosic particles from the first mixture are mixed, at least in a border area (18a) between the intermediate layer (17) and the back side layer (15).

Item 16. The building panel according to item 14 or 15, wherein at least 50% of the lignocellulosic particles in the first and/or third mixture has an aspect ratio of between 1:1 and 20:1, or between 1:1 and 10:1.

Item 17. The building panel according to any one of the items 14-16, further comprising:
a mechanical locking device (30a; 30b) arranged along at least one edge (25, 26, 27, 28) of the building panel, wherein the mechanical locking device (30a; 30b) is configured for horizontal and/or vertical locking of similar or essentially identical building panels (10, 10′, 10″) in an assembled position, the mechanical locking device (30a; 30b) comprising
an upper surface (40a; 60a), which is arranged in a front side area (26b; 28b) of the at least one edge (25, 26, 27, 28) and which extends in an essentially parallel direction to a top surface (24), along at least one edge (25, 26, 27, 28), of the building panel, displaced from said top surface (24), wherein the upper surface (40a; 60a) is further arranged in the front side layer (19) of the building panel (10).

Item 18. The building panel according to item 17, wherein the mechanical locking device further comprises:
a locking strip (32; 52) with a locking element (34; 54), which is arranged in a back side area (26a; 28a) of the at least one edge (25, 26, 27, 28) and which extends in an essentially parallel direction to a back surface (29), along at least one edge (25, 26, 27, 28), of the building panel, wherein the locking strip (32; 52) and the locking element (34; 54) are arranged at least partly in the back side layer (15) of the building panel (10).

Item 19. The building panel according to item 18, wherein the locking strip (32; 52) and the locking element (34; 54) are arranged in the back side layer (15), such that at least 60%, or at least 80% of the locking strip (32; 52) and the locking element (34; 54) are arranged in the back side layer (15).

1. A method of producing a building panel comprising:
applying a back side layer comprising a first mixture of at least lignocellulosic particles and a binder,
applying an intermediate layer comprising a second mixture of at least lignocellulosic particles and a binder, on the back side layer,
applying a front side layer comprising a third mixture of at least lignocellulosic particles and a binder, on the intermediate layer, and
applying pressure and heat to form said panel, to cure the binders of the front side layer, the intermediate layer and the back side layer and produce the building panel,
wherein at least 50% of the lignocellulosic particles in the second mixture has an aspect ratio of between 1:1 and 30:1.

2. The method according to claim 1, wherein lignocellulosic particles from the second mixture and lignocellulosic particles from the third mixture are mixed, at least in a border area between the intermediate layer and the front side layer.

3. The method according to claim 1, wherein lignocellulosic particles from the second mixture and lignocellulosic particles from the first mixture are mixed, at least in a border area between the intermediate layer and the back side layer.

4. The method according to claim 1, wherein at least 50% of the lignocellulosic particles in the first and/or third mixture has an aspect ratio of between 1:1 and 30:1.

5. The method according to claim 1, wherein the ratio between the amount of the applied second mixture and the total amount of the applied first and third mixture is between 80:20 and 20:80.

6. The method according to claim 1, wherein the ratio between the amount of the applied first mixture and the amount of the applied third mixture is between 40:60 and 60:40.

7. The method according to claim 1, wherein the third mixture and/or the first mixture comprises an amount of binder between 3% and 35%.

8. The method according to claim 1, further comprising applying a front side element on the front side layer prior to applying pressure and heat to form said panel, wherein the front side layer is configured to attach to the front side element when pressure and heat is applied to form said panel.

9. The method according to claim 8, wherein the front side element is chosen from a group consisting of: a paper sheet, a resin impregnated paper sheet, a polymer-based sheet, a cork-based element, a prefabricated powder-based sheet, or a powder layer comprising wood fibres and binder.

10. The method according to claim 8, wherein the front side element is a wood veneer element.

11. The method according to claim 10, wherein the front side layer is configured to penetrate into open features of the wood veneer and at least partly fill such open features when pressure and heat is applied.

12. The method according to claim 1, wherein the third mixture further comprises colorant.

13. The method according to claim 1, further comprising providing a back side element on which the back side layer is applied prior to applying pressure and heat to form said panel, wherein the back side layer is configured to attach to the back side element when pressure and heat is applied to form said panel.

14. The method according to claim 13, wherein the back side element is chosen from a group consisting of: a paper sheet, a resin impregnated paper sheet, a polymer-based sheet, a prefabricated powder-based sheet or a powder layer comprising wood fibres and binder.

15. The method according to claim 13, wherein the back side element is a wood veneer element.

16. The method according to claim 1, further comprising:
creating a mechanical locking device along at least one edge portion of the building panel, wherein the mechanical locking device is configured for horizontal and/or vertical locking of similar or essentially identical building panels in an assembled position, the mechanical locking device comprising
an upper surface, which is arrange in a front side area of the at least one edge portion, which extends in an essentially parallel direction to a top surface, along at least one edge portion, of the building panel, and which is displaced from said top surface, wherein the upper surface is arranged in the front side layer.

17. The method according to claim 16, wherein the mechanical locking device further comprises:
a locking strip with a locking element, arranged in a back side area of the at least one edge portion and which extends in an essentially parallel direction to a back surface, along at least one edge portion, of the building panel, wherein the locking strip and the locking element are arranged at least partly in the back side layer.

18. The method according to claim 17, wherein at least 60% of the locking strip and the locking element are created in the back side layer.

19. The method according to claim 1, wherein the building panel is a floor panel, a wall panel or a furniture component.

20. A building panel comprising
a multi-layered substrate comprising
a back side layer comprising lignocellulosic particles and a binder,
an intermediate layer comprising lignocellulosic particles and a binder, arranged on the back side layer, and
a front side layer comprising lignocellulosic particles and a binder, arranged on the intermediate layer,
wherein the back side layer was formed from a first mixture, the intermediate layer was formed from a second mixture and the front side layer was formed from a third mixture, and
wherein at least 50% of the lignocellulosic particles in the second mixture has an aspect ratio of between 1:1 and 30:1.

21. The building panel according to claim 20, wherein lignocellulosic particles from the second mixture and lignocellulosic particles from the third mixture are mixed, at least in a border area between the intermediate layer and the front side layer.

22. The building panel according to claim 20, wherein lignocellulosic particles from the second mixture and lignocellulosic particles from the first mixture are mixed, at least in a border area between the intermediate layer and the back side layer.

23. The building panel according to claim 20, wherein at least 50% of the lignocellulosic particles in the first and/or third mixture has an aspect ratio of between 1:1 and 20:1.

24. The building panel according to claim 20, further comprising a front side element attached to the front side layer of the multi-layered substrate.

25. The building panel according to claim 24, wherein the front side element is chosen from a group consisting of: a paper sheet, a resin impregnated paper sheet, a polymer-based sheet, a prefabricated powder-based sheet or a powder layer comprising wood fibres and binder.

26. The building panel according to claim 24, wherein the front side element is a wood veneer element.

27. The building panel according to claim 20, further comprising a back side element attached to the back side layer of the multi-layered substrate.

28. The building panel according to claim 27, wherein the back side element is chosen from a group consisting of: a paper sheet, a resin impregnated paper sheet, a polymer-based sheet, a prefabricated powder-based sheet or a powder layer comprising wood fibres and binder.

29. The building panel according to claim 27, wherein the back side element is a wood veneer element.

30. The building panel according to claim 20, further comprising:
a mechanical locking device arranged along at least one edge of the building panel, wherein the mechanical locking device is configured for horizontal and/or vertical locking of similar or essentially identical building panels in an assembled position, the mechanical locking device comprising
an upper surface, which is arranged in a front side area of the at least one edge, which extends in an essentially parallel direction to a top surface, along at least one edge, of the building panel, and which is displaced from said top surface, wherein the upper surface is further arranged in the front side layer of the building panel.

31. The building panel according to claim 30, wherein the mechanical locking device further comprises:
a locking strip with a locking element, which is arranged in a back side area of the at least one edge and which extends in an essentially parallel direction to a back surface, along at least one edge, of the building panel, wherein the locking strip and the locking element are arranged at least partly in the back side layer of the building panel.

32. The building panel according to claim 31, wherein the locking strip and the locking element are arranged in the back side layer, such that at least 60% of the locking strip and the locking element are arranged in the back side layer.

33. The building panel according to claim 20, wherein the panel is a floor panel, a wall panel, or a furniture component.
